(19) United States
(12) Patent Application Publication
(10) Pub. No.: US 2016/0328273 A1
(43) Pub. Date: Nov. 10, 2016

(54) OPTIMIZING WORKLOADS IN A WORKLOAD PLACEMENT SYSTEM

(71) Applicant: SAP SE, Walldorf (DE)

(72) Inventors: Karsten Molka, Belfast (GB); Giuliano Casale, Pavia (IT); Thomas Molka, Belfast (GB); Laura Moore, Belfast (GB)

(21) Appl. No.: 14/704,462

(22) Filed: May 5, 2015

(51) Int. Cl. G06F 9/50; G06F 9/48

(52) U.S. Cl. CPC G06F 9/5083; G06F 9/4881

(57) ABSTRACT

The disclosure generally describes computer-implemented methods, software, and systems, including a method for creating and incorporating an optimization solution into a workload placement system. An optimization model is defined for a workload placement system. The optimization model includes information for optimizing workflows and resource usage for in-memory database clusters. Parameters are identified for the optimization model. Using the identified parameters, an optimization solution is created for optimizing the placement of workloads in the workload placement system. The creating uses a multi-start approach including plural initial conditions for creating the optimization solution. The created optimization solution is refined using at least the multi-start approach. The optimization solution is incorporated into workload placement system.

### BACKGROUND

The present disclosure relates to optimizing the execution of workloads.

Cloud-based processors can execute workloads received from various sources. The workloads, for example, may have different processing requirements. For example, the processing requirements may include, for each the workloads, different resources to be used and/or types of processing to be done. Workloads can be processed, for example, in various ways, such with or without regard to various optimization techniques.

### SUMMARY

The disclosure generally describes computer-implemented methods, software, and systems for creating and incorporating an optimization solution into a workload placement system. For example, an optimization model is defined for a workload placement system. The optimization model includes information for optimizing workflows and resource usage for in-memory database clusters. Parameters are identified for the optimization model. Using the identified parameters, an optimization solution is created for optimizing the placement of workloads in the workload placement system. The creating uses a multi-start approach including plural initial conditions for creating the optimization solution. The created optimization solution is refined using at least the multi-start approach. The optimization solution is incorporated into workload placement system.

One computer-implemented method includes: defining an optimization model for a workload placement system, the optimization model including information for optimizing workflows and resource usage for in-memory database clusters; identifying parameters for the optimization model; creating, using the identified parameters, an optimization solution for optimizing the placement of workloads in the workload placement system, the creating using a multi-start approach including plural initial conditions for creating the optimization solution; refining the created optimization solution using at least the multi-start approach; and incorporating the optimization solution into the workload placement system.

In some implementations, self-service business intelligence (BI) tools can be used, e.g., that provide access to the data in different ways by different users and/or types of users. For example, one motive behind the use and the evolution of self-service BI tools can be to increase the ease of use for an end user, who may be an executive or a common user. In a typical scenario, for example, each of these end users can perform the same actions on different data from the same domain.

Some implementations include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes (or causes the system) to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect, combinable with any of the previous aspects, defining the optimization model includes: identifying at least one optimization objective for the optimization model, the at least one optimization objective selected from a group comprising query response times, query throughputs, memory occupation, and hardware/energy cost; identifying and adding response time, throughput and resource constraints to an optimization program in the workload placement system, the response time, throughput and resource constraints including a maximum response time, a minimum throughput, a maximum server utilization, and a maximum memory usage, the identifying and adding using the at least one optimization objective; and setting performance model constraints in the optimization program.

In a second aspect, combinable with any of the previous aspects, identifying parameters for the optimization model includes: identifying service level objective parameters, including actual values for response time and throughput constraints; identifying resource constraint parameters, including actual values for server utilization and memory occupation; generating traces for use in the workload placement system, the traces creating a trace set for collecting monitored performance of in-memory database clusters, and extracting, from the created trace set, performance-based parameters for use in the optimization model.

In a third aspect, combinable with any of the previous aspects, refining the optimization solution includes updating the optimization program in the workload placement system and refining the optimization solution based at least on the updating.

In a fourth aspect, combinable with any of the previous aspects, updating the optimization program in the workload placement system includes using at least load-dependent contention probabilities in the optimization program.

In a fifth aspect, combinable with any of the previous aspects, updating the optimization program in the workload placement system includes replacing performance model constraints in the optimization program with improved performance model constraints.

In a sixth aspect, combinable with any of the previous aspects, the method further comprises pre-processing classes of workloads in the workload placement system, including performing a complexity reduction on the workloads, the pre-processing occurring prior to incorporating the optimization solution into the workload placement system, and the pre-processing including clustering classes of current workloads into a subset of classes of related workloads, including creating a reduced number of classes of workloads.

In a seventh aspect, combinable with any of the previous aspects, the method further comprises post-processing the classes of the workloads, including using class clusters identified in pre-processing the classes of workloads and assigning original classes the same routing probability as the class cluster a class belongs to, the post-processing occurring prior to incorporating the optimization solution into workload placement system.

In a seventh aspect, combinable with any of the previous aspects, incorporating the optimization solution into workload placement system includes applying the class routing probabilities to the classes of current workloads.

The subject matter described in this specification can be implemented in particular implementations so as to realize one or more of the following advantages. Account memory occupancy is taken into account when modeling in-memory databases, providing a competitive edge in delivering in-memory database cloud capabilities. Multi-tenancy features of cloud storage are more efficient. Resource utilization is improved, providing cost efficiency and reducing total cost of ownership (TCO) of cloud solutions. Workload placement is optimized to ensure various workloads are not affected by performance interference from other workloads. Capabilities are improved by predicting performance behavior of workloads, providing an improved sustained performance experience for customers and reducing potential service level violations. Capabilities are improved by predicting and anticipating resource requirements for efficient resource and capacity planning.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1A is a block diagram of an example system 100 for creating and incorporating an optimization solution into a workload placement system.

FIG. 1B shows a flow diagram of an example process 150 for comparing historical load dispatch ratios with optimal load dispatch ratios from a last optimization solution.

FIG. 1C is a graph of an example predicted response time errors versus workload simulation.

FIG. 2 is a graph of example potential improvement of resource usage.

FIGS. 3A-3D show graphs representing example OLAP workload characteristics.

FIG. 4A is a diagram of a multiclass fork join queueing model of an in-memory database server.

FIGS. 4B-4F list equations used for implementations described herein

FIG. 5 is a diagram showing an example service demand estimation for an OLAP query.

FIGS. 6A-6D show example comparisons of predicted per-class response times relative to trace class response times.

FIGS. 7A-7C show example mean response times.

FIGS. 8A-8C show example predicted response times across different hardware types.

FIG. 9 shows an example model of an in-memory cluster subject to load optimization.

FIGS. 10A-10B show graphs of example predicted peak memory occupations under multi-user scenarios.

FIGS. 11A-11B show example scenarios of global optimization.

FIGS. 12A-12B show optimized placements of workloads under light and heavy loads.

FIG. 13 shows an example methodology for optimization refinement and evaluation against simulation.

FIGS. 14A-14C show example improvements in simulated memory occupation.

FIGS. 15A-15B show example service demand estimations for an OLAP query.

FIGS. 16A-16C show example normalized query classes for different numbers of k-means clusters.

FIG. 17 is a flow diagram for an example process for creating and incorporating an optimization solution into a workload placement system.

FIG. 18 is a flow chart showing an example process for using constraints to generate a model.

FIG. 19 shows a graph representing an example for creating an optimization solution using a multi-start approach.

FIG. 20 shows a graph representing an example for creating an optimization solution using a refinement approach.

Like reference numbers and designations in the various drawings indicate like elements.

### DETAILED DESCRIPTION

This disclosure generally describes computer-implemented methods, software, and systems for creating and incorporating an optimization solution into a workload placement system. For example, a server used for receiving and processing workloads in the cloud can receive workloads that are to be executed. In some implementations, optimization can occur, e.g., to make the processing of the workloads more efficient.

Contention-Aware Workload Placement for in-Memory Databases in Cloud Environments

Big data processing is driven by new types of in-memory database systems. In some implementations, analytical modeling can be applied to efficiently optimize workload placement for such systems, as described in this disclosure. For example, response time approximations can be made for in-memory databases based on, for example, fork join queuing models and contention probabilities to model variable threading levels and per-class memory occupation under analytical workloads. The approximations can be combined, for example, with a generic non-linear optimization methodology that seeks, for optimal load dispatching, routing probabilities in order to minimize memory swapping and resource utilization. The approach can be compared, for example, with state-of-the-art response time approximations using real data from an in-memory relational database system. The models may show, for example, markedly improved accuracy over existing approaches, at similar computational costs.

### INTRODUCTION

Big data analytics can be advanced by a new type of database systems that exploit in-memory technology combined with latest hardware technologies, including flash storage, field-programmable gate arrays (FPGAs) and graphics processing units (GPUs), to sharply optimize request throughputs and latencies. Case studies may show, for example, that in-memory databases can achieve tremendous speedups, outperforming traditional disk-based database systems by several orders of magnitude. As a result, in-memory systems may be in high commercial demand as part of cloud software-as-a-service offerings. This use can pose new challenges to the management of these applications in cloud infrastructures, since architectural design, sizing and pricing methodologies may not exist that are focused explicitly on in-memory technologies.

For example, one important challenge can be to enable better decision support throughout planning and operational phases of in-memory database cloud deployments. However, this can require novel performance and cost models that are able to capture in-memory database characteristics in order to drive deployment supporting optimization programs. Recent research may increasingly focus on management problems of this kind. In particular, recent work on consolidation and scheduling of applications in cloud environments may emphasize the importance of accounting for different resource and workload dimensions in order to find good solutions to provisioning problems. Other research may address the challenges of predicting workload performance using machine learning techniques, buffer pool, and queueing models. However, the research may not adequately account for the highly-variable threading levels of analytical workloads in in-memory databases.

This document addresses decision support challenges in both planning and operational phases, e.g., by tackling the problem of placing analytical workloads in clusters of big data analytics systems. Such clusters can provide, for example, back-ends for cloud-based services. In particular, this document introduces a load dispatching framework that employs a generic optimization methodology specifically tailored to multi-threaded big data analytics applications. The framework optimizes workload placement for these systems in order to improve performance and reduce costs from several perspectives. The framework can be applied, for example, to big data analytics clusters that are continuously monitored, and the framework can provide performance measurements. In addition, the framework can be used for what-if analyses, e.g., that can explore the effects of different hardware system configurations on performance and total cost of ownership.

In some implementations, the framework can seek to determiner load-dispatching routing probabilities that can load balance instances of big data systems for a set of clients respecting service level agreements (SLAs) in place with the customer. The framework can use, for example, a queueing modeling approach to describe the levels of contention at resources, such as to establish the likelihood that a sizing configuration will comply to SLAs. Furthermore, since applications for in-memory analytics may typically be memory-bound, it can be crucial that their sizing models are able to capture memory constraints, as memory exhaustion and swapping are more likely to happen in this class of applications. Conversely, existing sizing methods for enterprise applications have primarily focused on modeling mean CPU demand and request response times. The focus exists because memory occupation is typically difficult to model and requires the ability to predict the probability of a certain mix of queries being active at any given time. However, conventional probabilistic models can tend to be expensive to evaluate, leading to slow iteration speed when used in combination with numerical optimization. To cope with this issue, a framework can be introduced that is based on approximate mean-value analysis (AMVA), a classic methodology to obtain performance estimates in queueing network models. Particular observations can be made, for example, that current AMVA methods are unable to correctly capture the effects of variable threading levels in in-memory database systems. As such, a correction can be proposed that markedly improves accuracy. The approach can be called thread-placement AMVA (TP-AMVA), e.g., retaining the same computational properties of AMVA, yet simple and inexpensive to integrate into optimization programs. As demonstrated below, multi-start interior point methods can be effectively used to solve the resulting optimization programs. This can validate the approach, for example, using real traces from a commercial in-memory database, e.g., an in-memory relational database system.

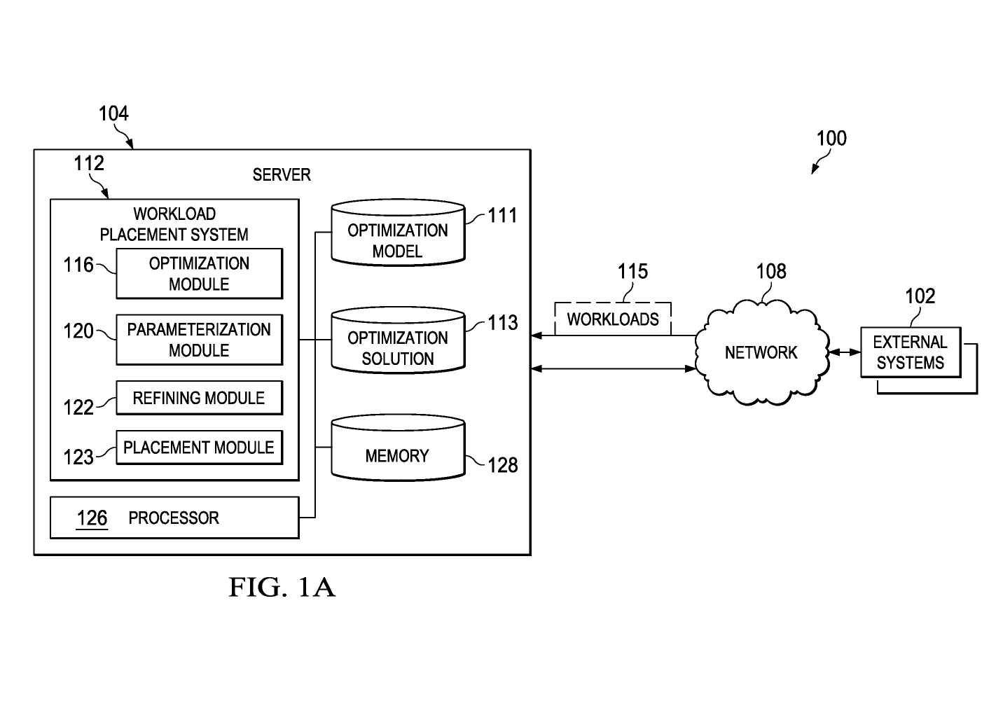

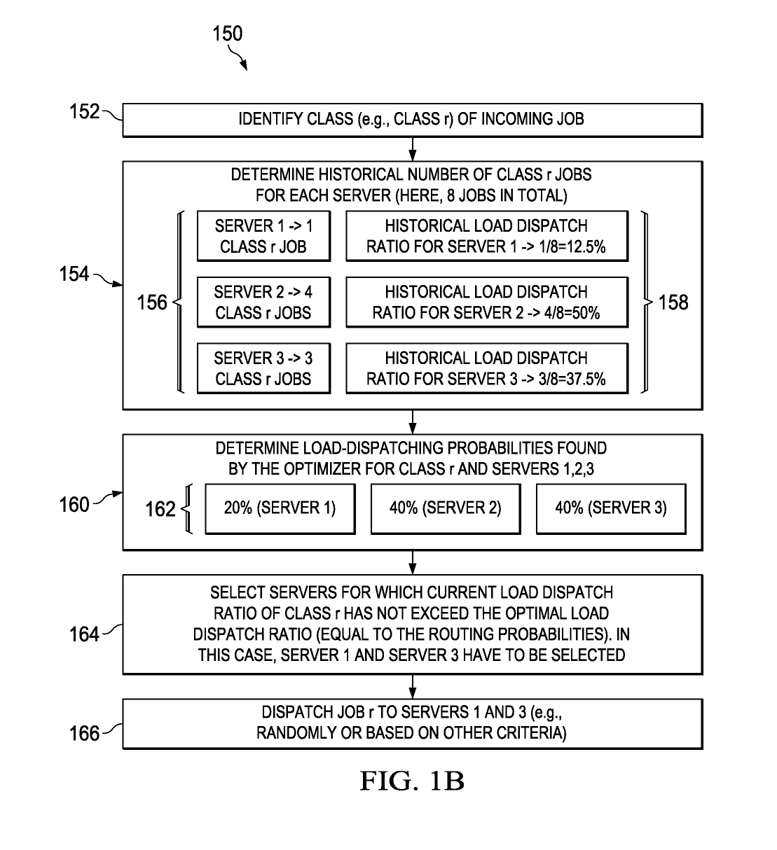

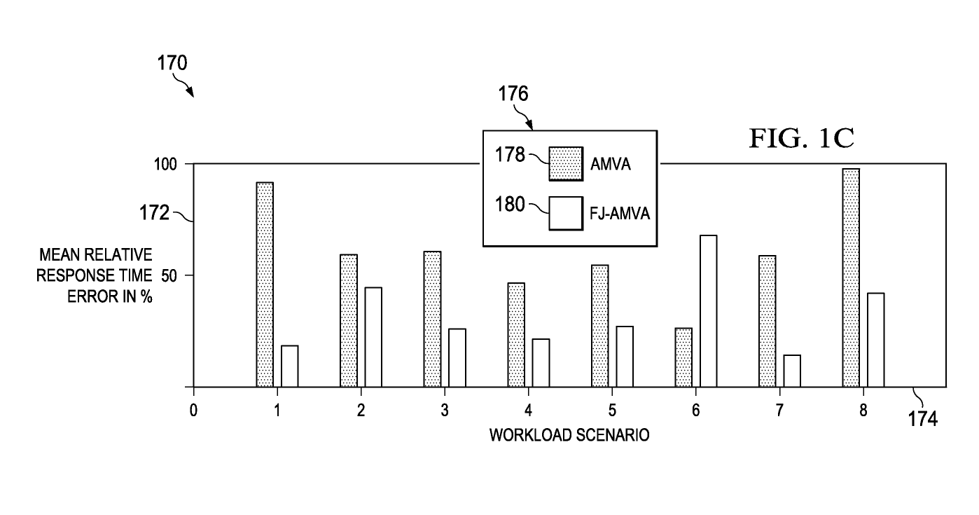

FIG. 1A is a block diagram of an example system 100 for creating and incorporating an optimization solution into a workload placement system. Specifically, the illustrated environment 100 includes, or is communicably coupled with, plural external systems 102 and a server 104, connected using a network 108. For example, the environment 100 can use capabilities of the server 104 to process workloads 115 received from the plural external systems 102.

At a high level, the server 104 comprises an electronic computing device operable to store and provide access to workload processing resources for use by the external systems 102. An optimization model 111, for example defined for a workload placement system 112, can include information for optimizing workflows and resource usage for in-memory database clusters, such as for workloads 115 processed by the server 104. In some implementations, a placement module 123 can place workloads 115, e.g., to various servers in an optimized way, as described in this document.

In some implementations, the placement module 123 can provide the following functionality. The placement module 123 can collect and store information about which job classes and how many jobs per class are executed on each server. The placement module 123 can determine an optimal load dispatch ratio (e.g., using class routing probabilities) from the optimization module 116. For each incoming job, for example, the placement module 123 can compare historical load dispatch ratios with optimal load dispatch ratios from last optimization solution.

FIG. 1B shows a flow diagram of an example process 150 for comparing historical load dispatch ratios with optimal load dispatch ratios from a last optimization solution. The placement module 123, for example, can execute the process 150 for each incoming job. As such, the process 150 is an example of how load dispatching can be used (e.g., assuming workloads don't change). If workloads change, for example, then the optimization can be re-run.

At 152, the class of incoming job is identified. For example, the class can be class r. At 154, the historical number of class r jobs (e.g., eight jobs) for each server is determined. In this example, servers 156 (e.g., Servers 1, 2 and 3) can have a certain number of class r jobs, e.g., 1, 4 and 3, respectively. This results in historical load ratios 158 of 12.5%, 50%, and 37.5% for the servers 1, 2 and 3, respectively.

At 160, load-dispatching probabilities found by the optimizer for class r and servers 1, 2, and 3 are determined. For example, probabilities 162 that are determined can be 20%, 40%, and 40% for the servers 1, 2 and 3, respectively. At 164, servers are selected for which the current load dispatch ratio of class r has not exceeded the optimal load dispatch ratio (e.g., equal to the routing probabilities). In this case, Server 1 and Server 3 can be selected. At 166, jobs for class r are dispatched to servers 1 and 3 (e.g., randomly or based on other criteria).

As used in the present disclosure, the term “computer” is intended to encompass any suitable processing device. For example, although FIG. 1A illustrates a single server 104, the environment 100 can be implemented using two or more servers 104, as well as computers other than servers, including a server pool. Indeed, the server 104 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 104 may be adapted to execute any operating system, including Linux, UNIX, Windows, Mac OS®, Java™, Android™, iOS or any other suitable operating system. According to some implementations, the server 104 may also include, or be communicably coupled with, an e-mail server, a web server, a caching server, a streaming data server, and/or other suitable server(s). In some implementations, components of the server 104 may be distributed in different locations and coupled using the network 108.

In some implementations, the server 104 includes a workload placement system 112 that received workloads 115 to be processed at the server 104. For example, the workload placement system 112 can receive workloads 115 from the external systems 102. The workload placement system 112 can use an optimization solution 113 for placement and execution of workloads 115 at the server 104.

The workload placement system 112 includes an optimization module 116, for example, that can use the identified parameters to create the optimization solution 113 for the optimization model 111. For example, the creating can use a multi-start approach including plural initial conditions for creating the optimization solution, as described below.

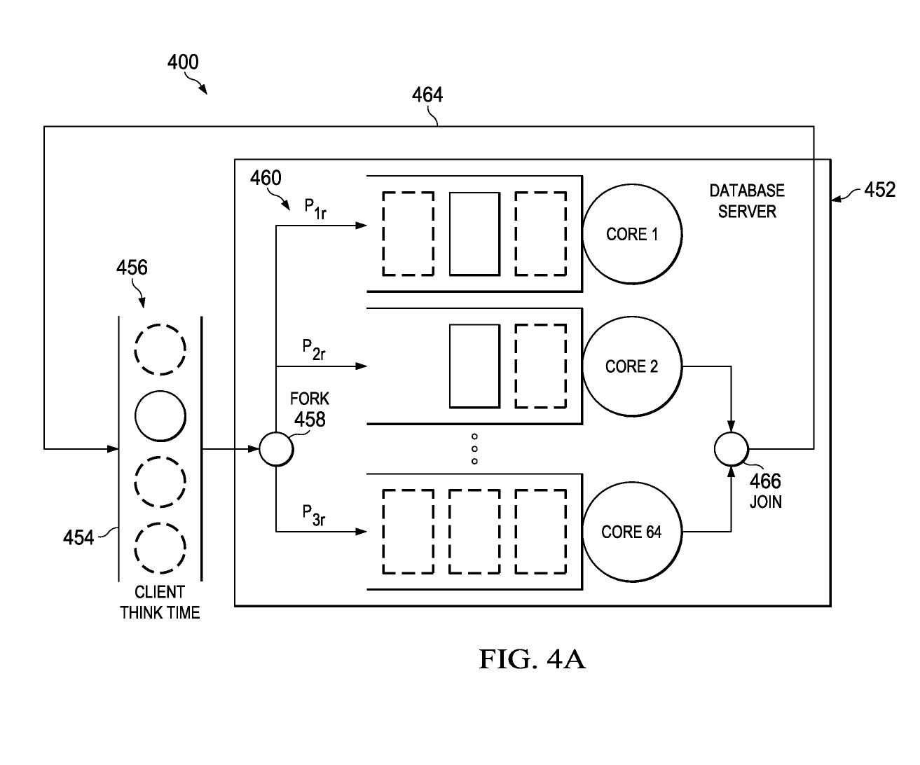

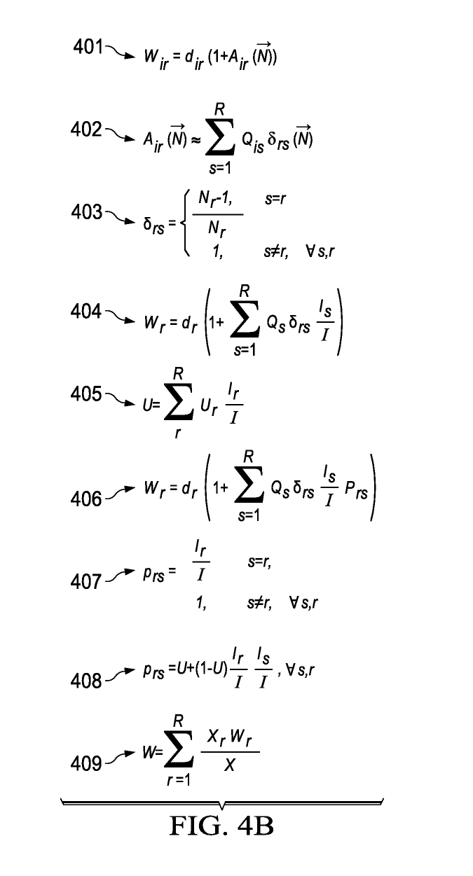

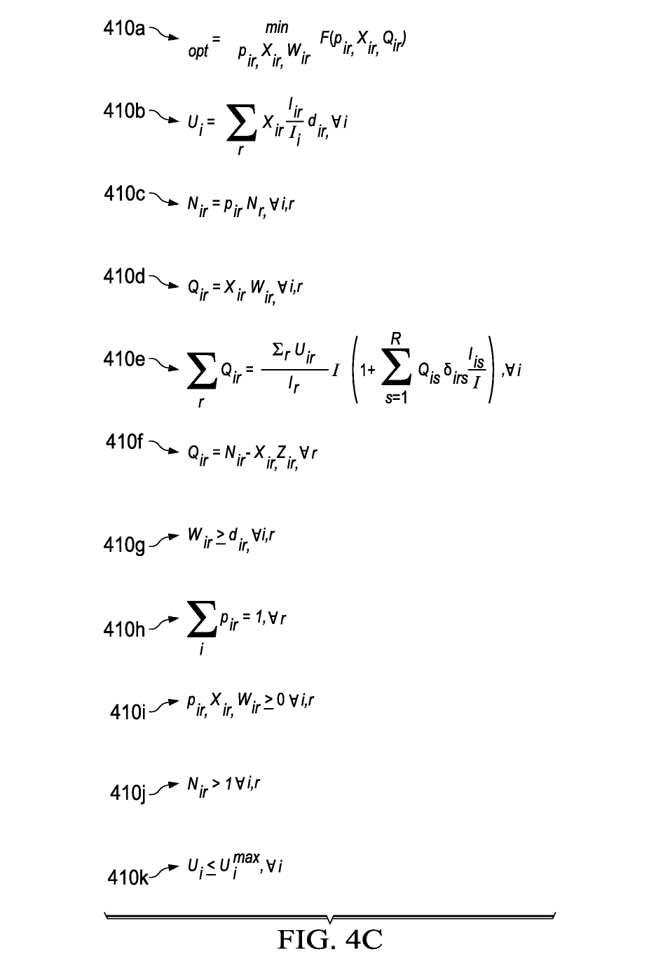

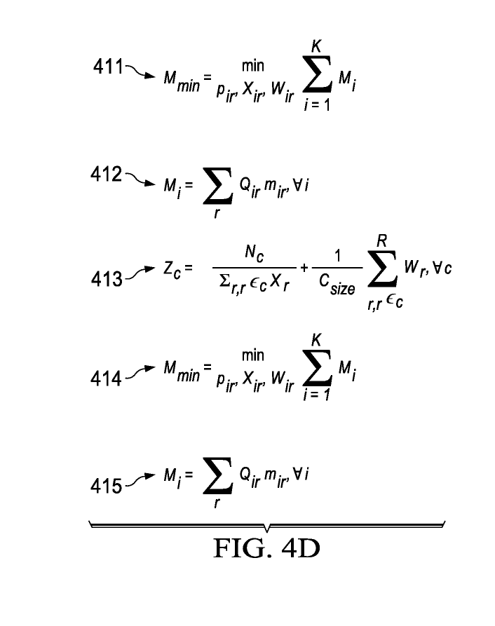

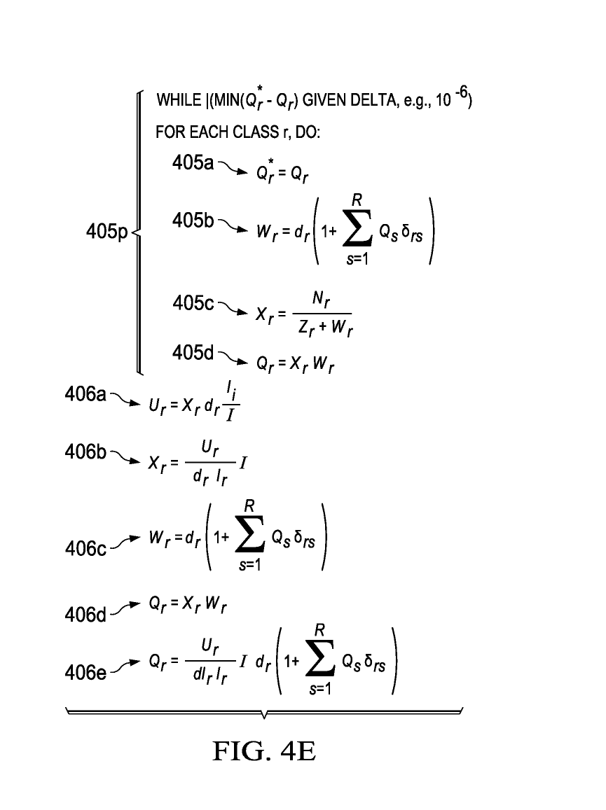

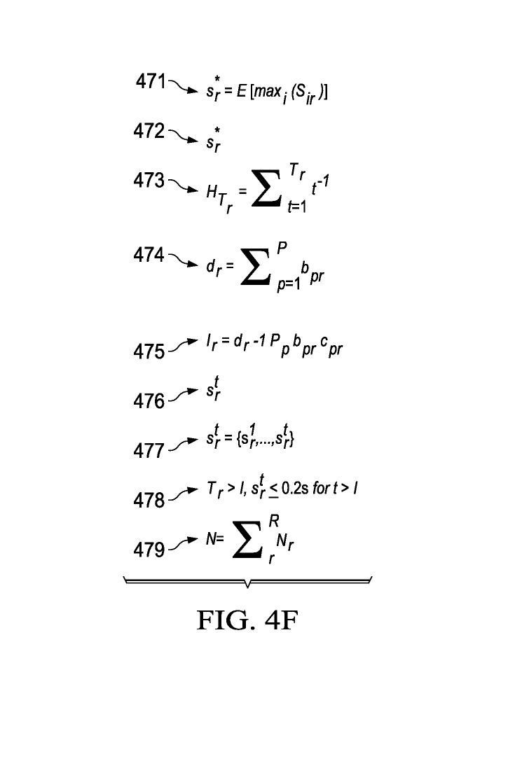

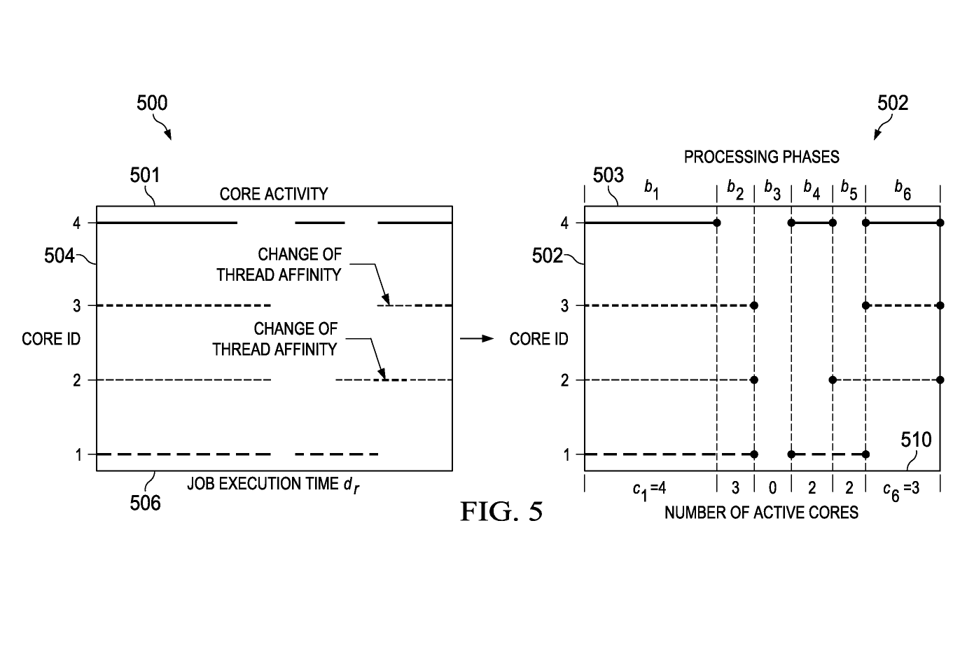

The workload placement system 112 includes a parameterization module 120, for example, that can identify parameters for the optimization model 111. The parameters can include, for example, parameters described below with reference to FIGS. 4-5. In some implementations, the parameters can include service level objective parameters, including actual values for response time and throughput constraints, resource constraint parameters, including actual values for server utilization and memory occupation, traces for use in the workload placement system for creating a trace set for collecting monitored performance of in-memory database clusters, and performance-based parameters for use in the optimization model.

The workload placement system 112 further includes a refining module 122. For example, the refining module 122 can use the optimization solution 113 to refine the optimization model 111. Refining the optimization solution can include, for example, updating the optimization program in the workload placement system 112 and refining the optimization solution based at least on the updating. For example, updating the optimization program in the workload placement system can include using at least load-dependent contention probabilities in the optimization program. In another example, updating the optimization program in the workload placement system can include replacing performance model constraints in the optimization program with improved performance model constraints

The server 104 further includes a processor 126 and memory 128. Although illustrated as the single processor 126 in FIG. 1A, two or more processors 126 may be used according to particular needs, desires, or particular implementations of the environment 100. Each processor 126 may be a central processing unit (CPU), an application specific integrated circuit (ASIC), a field-programmable gate array (FPGA), or another suitable component. Generally, the processor 126 executes instructions and manipulates data to perform the operations of the client device 102. Specifically, the processor 126 executes the functionality required to receive and process requests from the client device 102 and analyze information received from the client device 102.

The memory 128 (or multiple memories 128) may include any type of memory or database module and may take the form of volatile and/or non-volatile memory including, without limitation, magnetic media, optical media, random access memory (RAM), read-only memory (ROM), removable media, or any other suitable local or remote memory component. The memory 128 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 104. In some implementations, memory 128 includes the transaction repository and the optimization solution 113. Other components within the memory 128 are possible.

Each external system 102 of the environment 100 may be any computing device operable to connect to, or communicate with, at least the server 104 via the network 108 using a wire-line or wireless connection. In general, the client device 102 comprises an electronic computer device operable to receive, transmit, process, and store any appropriate data associated with the environment 100 of FIG. 1A.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, Visual Basic, assembler, Perl®, any suitable version of 4GL, as well as others. While portions of the software illustrated in FIG. 1A are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

FIG. 1C is a graph 170 of an example predicted response time errors 172 versus workload simulation 174. For example, a new response time approximation is also proposed, as described herein, that introduces load dependent contention probabilities, e.g., improving the accuracy of predictions significantly. Moreover, a generic optimization methodology is introduced, and the generic optimization methodology is compared against global optimization. Furthermore, a refinement step can be included in the optimization methodology, and expected improvements can be validated against simulation. As shown in key legend 176, graph 170 bars that are shaded represent AMVA values 178. FJ-AMVA 180 values are represented with unshaded bars.

In summary, main aspects of the approach described herein include the following. First, the approach includes an analytic response time approximation for in-memory databases that considers thread-level fork join and contention probabilities. Second, the approach includes a generic and extensible optimization methodology that seeks load-dispatching routing probabilities to optimize performance and cost for in-memory clusters subject to resource constraints. Third, the approach includes parameterization and evaluation of models with real traces of an in-memory database system. Fourth, the approach includes an experimental validation that reveals the applicability of local search strategies for up to 512 servers on a short time scale using class clustering.

While an overview of the approach has been provided, more detailed information is provided below. For example, a motivation section describes the motivation for the approach and associated research. A modeling section introduces the characteristics of an in-memory database system and presents a response time approximation, which is evaluated against real traces from a commercial in-memory database in a prediction model validation section. In an optimization section, a generic sizing methodology is developed based on a response time approximation, which provides a numerical evaluation in a numerical evaluation section. A related work section discusses related work and alternate implementations. A conclusions section concludes this document and outlines future work.

### Motivation

In-memory databases can be an increasingly important type of big data analysis systems capable of processing heavily memory-intensive workloads in a parallel fashion. For example, in order to support sizing decisions for such systems, it can be essential to develop models that are able to capture the key properties of in-memory databases, such as response times and request throughputs. Existing analytical approaches include, for example, approximate mean value analysis (AMVA), widely used to model the performance of multi-tier applications, and state-of-the-art AMVA based methods, i.e. fork join AMVA (FJ-AMVA). These and other analytical approaches may be insufficient in correctly capturing the extensive and variable threading-level introduced by analytical workloads. To demonstrate this, these two methods can be parameterized from real traces of an in-memory database, and their response time predictions can be compared, for example, with a validated in-memory database simulator. An excerpt of these results is provided in FIG. 1C, which depicts the relative response time error of AMVA and FJ-AMVA compared with a simulator under different workloads. It may be observed that using both AMVA and FJAMVA can occasionally result in large prediction errors. In particular, it may be determined that traces do not meet the exponentiality assumptions and thus the assumptions of FJAMVA, which is one of the reasons for its performance on the dataset. In summary, the results may clearly motivate the need for enhanced in-memory database performance models that can cope with extensive variable threading-levels introduced by analytical workloads.

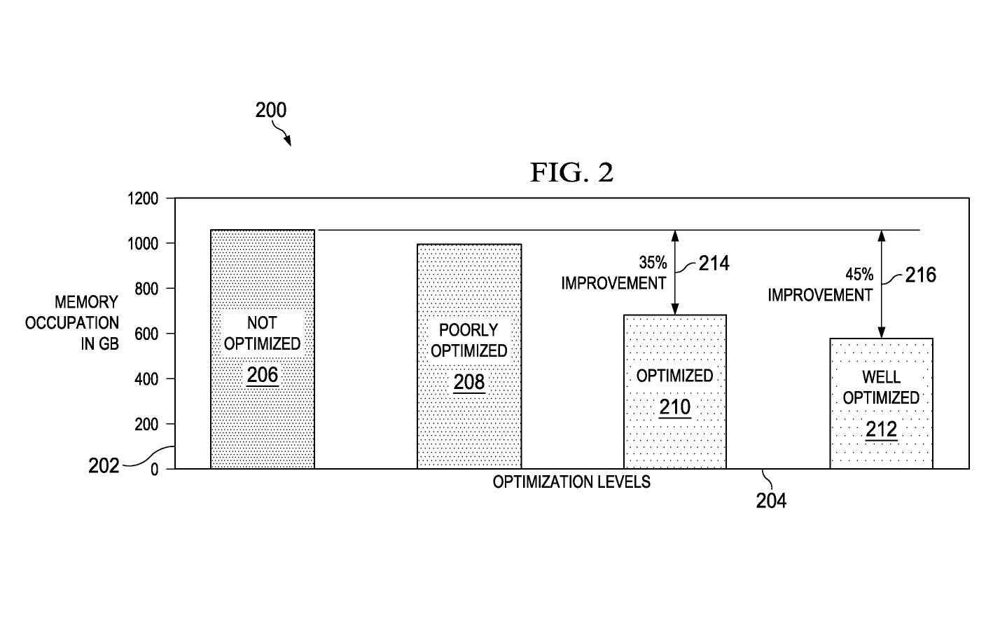

Secondly, additional information can be determined regarding the peak memory occupation of an in-memory database cluster under particular workload placements. More specifically, an inference can be made of the memory occupation from the number of jobs that are concurrently processed in such a cluster (e.g., as detailed below). To do so, response time approximation TP-AMVA can be integrated into an optimization program, and the respective number of jobs in contention for resources at each server can be computed. The solution of this optimization program can include a workload placement, which impacts the memory occupation of the cluster. FIG. 2 is a graph 200 of example potential improvement of resource usage. For example, four different workload placements 206-212 in a four server scenarios are shown. The associated memory occupation 202 can be analyzed relative to ascending optimization levels 204 for the workload placements 206-212 (e.g., not optimized, poorly optimized, optimized and well optimized). As revealed above with respect to FIG. 2, workload placement can have a huge impact on the memory occupation, indicating that improvements of memory usage up to 45% are possible compared to a non-optimized workload placement. This can strongly motivate an approach of efficiently seeking for optimal workload placements.

Modeling in-Memory Database Performance

### Database Characteristics Under OLAP

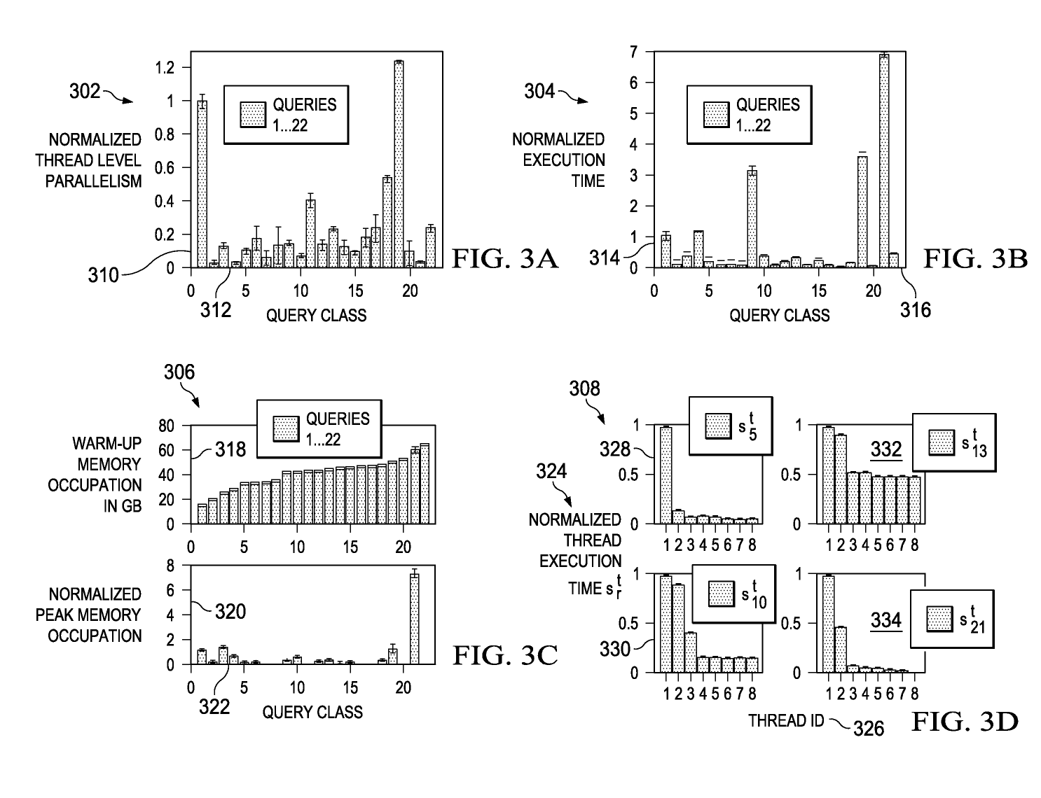

In-memory database systems can provide back ends to on premise enterprise applications and on-demand cloud-based services. In particular, in-memory databases can be optimized to execute analytical business transactions, e.g., online analytical processing (OLAP). These types of transactions can represent read-only workloads and can thus be entirely processed in main memory. Due to their analytical nature, OLAP workloads can be computationally intensive and can also show high variability in their threading levels. Before going into detail about the modeling of such in-memory database systems, diverse characteristics under OLAP workloads are discussed first. In some implementations, trace logs from benchmark experiments can be analyzed running in-memory relational database system. For example, using an IBM X5 4-socket database server configured with 1 TB main memory, a benchmark was run at a scale factor of 100×. The benchmark comprised a set of 22 OLAP queries, e.g., an extension to the TPC-H benchmark with an emphasis on analytical processing. FIGS. 3A-3D show graphs 302-308 representing example OLAP workload characteristics. For example, results of the trace log analysis for all 22 query classes are provided in FIGS. 3A-3C. All values have been obtained from isolated query runs and are shown with their respective standard deviations. For confidentiality, the results are normalized by the respective value of class 1. FIG. 3A presents the average number of CPU cores 310 used by each query class 312, e.g., denoted with thread level parallelism 1. As expected, a strong variability of the parallelism is present across all query classes, which can increase contention for resources under OLAP workload mixes. In addition, a varying computational expense for all OLAP queries is observed (e.g., normalized execution times 314 for query classes 316), as depicted in FIG. 3B. The memory intensive character of OLAP workloads is further revealed in FIG. 3C, e.g., by showing the (normalized) peak physical memory 320 temporarily occupied during the processing of queries (by query class 322), which varies on a gigabyte scale. To emphasize the importance of compression during the execution of OLAP workloads, FIG. 3C demonstrates, for example, that the benchmark dataset with a size of 1.3 TB is reduced to approximately 65 GB after conducting a warm-up run (warm-up memory axis 318) for each query class to pre-load required data into main memory.

### In-Memory Database Server Model

Although the in-memory database system is intensively used for business analytics, similar types of requests coming from analytics applications can recurrently hit the database system. The TPC-H benchmark used for the experiments can simulate this behavior of a fixed set of users that recurrently submit their requests to the database. Hence, this suggests the use of a closed workload model.

The execution of requests submitted by the benchmark involves major stages: a query planning stage and an execution stage. At a high level, the planning phase can involve the analysis of query structures by a query planner that subsequently creates an appropriate job execution plan. During the execution, for example, phase job execution plans can be forwarded to an admission buffer. Forwarding can depend on the query plan parallelism processed by one or several worker threads, where each worker thread is assigned to an available CPU core. Before worker threads can complete their task, processed information has to be synchronized, e.g. parallel data aggregation, before a query can leave the system.

FIG. 4A is a diagram of a multiclass fork join queueing model of an in-memory database server 452. For example, in order to model the query execution, performance models for in-memory databases can require a contention model that accurately captures hardware properties and application characteristics as introduced by analytical workloads. Further, as motivated by a high level of query parallelism shown in FIG. 3A, fork join queues (e.g., using fork 458) can be applied to model the execution of worker threads on processing cores 464 of a multi-core in-memory database system. In particular, processor sharing (PS) queues can be considered, where service times are generally distributed, e.g., independent and identically distributed random variables, and the variables can be combined with a multiclass closed queueing network. This can enable modeling of the execution of different workload classes that are recurrently submitted by a fixed set of users, as it is the case for the TPC-H benchmark. To model this behavior more accurately, a think time model for think times 454 can be additionally employed that captures the time between two request submissions. In addition to this, the think time model can account for database internal scheduling mechanisms. These mechanisms can rely in particular on admission buffers (e.g., an important part of the complex query processing and scheduling engines in in-memory database systems) used to delay job 456 executions in case database internal resources, such as until thread pools are exhausted. FIG. 4A shows the queueing model used to represent the in-memory database server 452. The queueing model, for example, can capture the behavior of query jobs split into several tasks 410 on arrival at the system, which can then be processed by worker threads and assigned to processing cores 414 in a probabilistic manner. This can include the synchronization aspect of parallel siblings at the join point 416 and the return to the think time buffer once a job is completed.

In some implementations, approaches to solve these types of queueing networks (QNs) via simulation can emphasize the difficulty in finding analytical solutions. Different approximations to QNs can be used, e.g., as will be described in the following introduction of a novel analytical response time correction to fork join queues, and as indicated with relevant notations in Table 1:

TABLE 1
Main Notation

| | |
|---|---|
| Symbol | Description |

Workload Parameters

| | |
|---|---|
| R | Number of query classes |
| bₚ | Length of processing phase p |
| cₚ | Number of active cores during p |
| dᵢᵣ,sᵢᵣ | Service demand and service time of class r at queue i |
| lᵣ | Number of cores used on average by class r |
| sᵣ^{t} | Service time of thread t of class r |
| Tᵣ | Number of threads per class r |
| \vec{N} | Vector with number of per-class jobs: N₁, . . . , N_{R} |
| \vec{Z} | Vector of per-class think times Z₁, . . . , Z_{R} |

Additional Parameters

| | |
|---|---|
| Iᵢ | Number of available processing cores at server i |
| pᵢᵣ | Probability of class r jobs being routed to station i |

Performance Measures

| | |
|---|---|
| Xᵢᵣ | Per-class throughput at queue i |
| Wᵢᵣ | Per-class residence time at queue i |
| Aᵢᵣ | Queue length at arrival instant of class r at queue i |
| Qᵢᵣ | Per-class queue length at queue i |
| Uᵢᵣ | Per-class utilization of queue i |
| Mᵢᵣ | Per-class memory utilization at server i |

### Approximations to Fork-Join Queues

In some implementations, widely-used exact analytical solutions for closed QNs, known as mean-value analysis (MVA), can determine the response time Wᵢᵣ for a job of class r at queueing center (core) i depending on the total number of per-class jobs \vec{N} in a system as shown in equation 401. FIGS. 4B-4F list equations used for implementations described herein.

Here, the response time is estimated by the service demand dᵢᵣ of the arriving job r at core i inflated by the number of jobs already queueing at i. More specifically, dᵢᵣ can be expressed as vᵢᵣsᵢᵣ, the product of visits vᵢᵣ to queue i and the service time sᵢᵣ at queue i, required in cases where a job is routed back to a queue before arriving at the join station. Furthermore, the arrival instant queue Aᵢᵣ(\vec{N}) counts for the total number of jobs queuing or being served at i at the arrival instant of a job of class r. Based on the arrival theorem for closed QNs, Aᵢᵣ(\vec{N}) can be expressed as Qᵢᵣ(\vec{N}−1ᵣ), which represents the queue length with one less class r job. MVA can be applied in a recursive fashion, but MVA gets intractable for problems with more than a few customer classes. In some implementations, this can be addressed by using an approximate MVA (AMVA) that employs a fixed-point iteration and estimates Aᵢᵣ via linear interpolation, as shown in equations 402 and 403.

However, temporal delays introduced by synchronization in fork join queues cannot be described with the above product-form models. Since MVA and AMVA are not applicable in that case, more recent approaches have tried to address this aspect. Some implementations can use a response time approximation called FJ-AMVA that sorts per-class residence times in descending order and scales them by a coefficient based on harmonic numbers, e.g., for better estimation of the synchronization overhead. Both approaches can assume sᵢᵣ to be the mean of the exponentially distributed service times sᵢᵣ. It can be shown that if sᵢᵣ are the same at every queue for a particular class r, maxᵢ(sᵢᵣ)×H_{Tr} equals equation 471, where equation 472 becomes the maximum service time of a job and equation 473 denotes the t-th harmonic number for job class r with T parallel tasks. While FJ-AMVA treats the heterogeneous case, in which sᵢᵣ does not have to be the same at every queue, both fork join approximations can require exponentially distributed service times. However, observation can determine that service times for all 22 TPC-H queries do not show an exponential distribution, but instead a generally low variability. This is pointed out in FIGS. 3B and 3D, e.g., by listing the per-class execution times and their standard deviations as well as the first eight longest running threads for a subset of the query classes. For example, FIG. 3D shows normalized thread execution times 324 (for T less than or equal to 8) associated with thread IDs 326 for different values of s. In this case, a maximum variability of ≈10% can occur for the TPC-H query template Q1. Relying on harmonic numbers may not be a favorable approach for scenarios with no exponentiality in service demands. Hence, this low variability can be expected to be problematic for FJ-AMVA, which motivates the need for a response time correction that does not rely on exponential service times.

### Response Time Correction

Since thread-level fork join cannot be directly expressed with equation 401, an analytical response time correction called TP-AMVA can be proposed which considers the placement of tasks in fork join queues. Further, unlike FJ-AMVA, TP-AMVA does not rely on exponential service time distributions. In particular, the fork join construct can be approximated with only one single queue, which can decrease processing time and can simplify the construct's integration into the optimization program. This abstraction does not consider the state of individual queues, but rather the average state of the system, which follows the MVA paradigm. Since queues are assumed to be all with the same processing rates and equal class routing probabilities, their mean queue length will be the same. Thus, to enforce SLAs, it is sufficient to consider the expression of just a single arbitrary queue. Moreover, since jobs are considered not to cycle within the fork-join construct, then dᵣ=vᵣsᵣ=sᵣ.

The following provides an incremental approach that is helpful to understand how each additional extension to the AMVA expression contributes to accuracy.

### Thread-Level Parallelism

At first, the query thread level parallelism l is introduced into the MVA expression in equation 401, since this is an important workload property. The correction can have the form shown in equation 404.

where the response time Wᵣ is calculated as the service demand dᵣ inflated by a factor that describes the service rate degradation under processor sharing due to jobs, which already compete for resources at the same queue. This factor is represented by the arrival queue length Aₛ=Qₛδᵣₛ, which can be estimated by employing a Bard-Schweitzer approximation. Then Aₛ is corrected by the factor lₛ/I to estimate the per-core queue length in a system with I cores based on the query parallelism l. This is possible because thread-level information is recorded for each query class, allowing a better approximation of the fork join feature. Response times Wᵣ, throughputs Xᵣ, and queue lengths Qᵣ can then be obtained by performing the AMVA fixed-point iteration. Similarly, to the arrival queue length, the utilization in a fork join system can be approximated as shown in equation 405.

Considering the assumptions about same processing rates and equal routing probabilities, it can be sufficient to take the expression of an individual arbitrary queue to obtain the mean total system utilization.

### Static Contention Probabilities

The expression in equation 404 can be improved further by an empirical calibration that considers static contention probabilities. This second step can follow the idea that an arriving class r job affects Wᵣ and Qᵣ depending on its routing probability pᵣ to a particular queue in the fork join construct. This effect can be accounted for in the second part of the summation term, e.g., by multiplying the class r queue length Qᵣ with pᵣ, rather than scaling dᵣ, e.g., to guarantee that job r sojourns for at least dᵣ in the system. This refinement step results in the expression shown in equation 406, where pᵣₛ is defined as shown in equation 407.

While equation 406 retains the same computational properties of equation 404, equation 406 can be expected to result in a more accurate estimation of response times under concurrent workloads.

### Load-Dependent Contention Probabilities

In this final step, the definition of contention probabilities can be further improve over equation 407. This extension can modify the queue length based on the probability of query pairs interfering with each other depending on the server utilization. With such an approach, it can be expected to be able to distinguish the impact of contention effects under light and heavy load scenarios more accurately. Therefore pᵣₛ can be defined as shown in equation 408.

The idea behind this approach is twofold. For example, under light load, the first summand in equation 408 can be neglected, since the system utilization is at a low level. That means the major contribution comes from the term (lᵣ/I)×(lₛ/I), expressing the probability that queries of class r are placed on the same queue as queries of class s. Under heavy load, this probability can be set to one, since it can be assumed that, if the number of parallel users is large enough, it will be unlikely that two queries do not interfere with each other. This is expressed by the first summand in equation 408, which becomes 1.0 while the contribution of the second summand goes against zero. While equation 408 can be expected to markedly improve accuracy over equations 404 and 406, equation 408 introduces a higher level of complexity than the latter when used in combination with nonlinear optimization. Hence, with the three AMVA extensions, the common problem is faced of choosing the right tradeoff between suitability of mathematical models for nonlinear optimization and their accuracy/complexity for respective predictions. To better justify which of the three AMVA extensions is most suitable for the optimization problem, an extensive experimental evaluation is described in the next section. During the evaluation, for example, the implementation of equation 404 is denoted with TP-AMVAₛₜₐₜ, equation 406 is denoted with TP-AMVA_{prob}, and equation 408 is denoted with TP-AMVA_{prob util}.

### Prediction Model Validation

### Experimental Setup and Methodology

To understand the performance of queueing predictive models, per-class prediction accuracy can be validated against real traces, e.g., from an IBM 4-socket in-memory database system. Subsequently, a sensitivity analysis can be conducted to explore the robustness of the technique under concurrent workloads while increasing the number of processing cores.

### Database Server Configuration and Trace Logs

For the evaluation, the TPC-H benchmark traces introduced above can be considered. For example, the traces can record measurements from isolated runs for all 22 TPC-H query templates as well as response times, throughputs and inter arrival times for benchmark scenarios with 1, 4, 8, 16 and 32 concurrent users. The former can be used to parameterize the models, whereas the latter can be considered for evaluation of the model prediction accuracy under concurrent workloads. In particular, the traces can be considered for three different hardware systems, each with the same installation, e.g., an IBM 4-socket system (IBM4) with 1 TB of main memory as well as the two 8-socket systems IBM8 and HP8, both configured with 2 TB main memory. For each of these systems, 2-socket and 4-socket NUMA (non-uniform memory access) configurations were benchmarked, including the 8-socket configuration under IBM8 and HP8. To account for the different system parameters under these additional configurations, such as the varying number of processing cores and service times, IBM4 trace log analysis, as described above) were run on the available datasets from the new 2-socket, 4-socket and 8-socket NUMA configurations.

### Service Demand Estimation

To parameterize the queueing model presented above, per-class service times and parallelism from the available traces need to be extracted. Since theses parameters have been extracted to drive in-memory database simulator, the process can be reviewed and subsequently extended for use with the analytical model. FIG. 5 is a diagram showing an example service demand estimation for an OLAP query. For example, FIG. 5 illustrates the extraction process, e.g. represented by an exemplary job that is executed on a 4-core system. For example, FIG. 5 Case 1a 500 shows core activity 501, which was sampled during the execution of the job. It can be seen that over time, all 4 cores were differently utilized, e.g., attributable to stalling threads or changes in thread affinity. For example, Case 1a 500 shows job execution times 506 by core ID 504. Based on the sampled core activity, the execution process of a query can be divided into P processing phases, as illustrated in Case 1b 502 for cores having core ID 504. Each processing phase 503 can be defined by its duration bₚ and its number of active processing cores cₚ 510, e.g., 4 active cores in processing phase 1 and no active cores in processing phase 3. As mentioned above, the extraction of processing phases and active cores can be done with the aim to provide fine-grained service requirements. However, a better approximation can favor a less complex parameterization that avoids additional processing overhead when integrated into optimization programs. This is another reason for determining the per-class service time dᵣ and thread-level parallelism lᵣ for use with the analytical model as aggregates of these measurements, as shown in equations 474 and 475. Since the parameterization of FJ-AMVA is similar, but relies on execution times of tasks pertaining to a query process, a more detailed description is provided below in a section that discusses estimating service demands for FJ-AMVA.

### Model Parameterization

To conduct the prediction model evaluation, AMVA, FJ-AMVA, and TP-AMVA can be implemented in MATLAB R2014a using the following parameterization based on estimated per-class service times and thread-level information.

For AMVA and TP-AMVA, the aggregated service demand dᵣ can be used, where jobs visit processing queues only once. An alternative parameterization of AMVA is also included, with dᵣ=(lᵣ/I)sᵣ to explore accuracy when using service times scaled by the thread level parallelism over the number of available processing cores. Throughout the evaluation, this parameterization can be denoted with AMVAᵥᵢₛᵢₜₛ. In contrast, FJ-AMVA can be parameterized with the service times of jobs at each queue sᵢᵣ. As detailed below in a section that provides a discussion of estimating service demands for FJ-AMVA, these values can be obtained from execution times of each active worker thread of equation 476 running during execution of a class r job. Then, each active worker thread of equation 476 can naturally represent the service times needed by FJ-AMVA, is mapped onto sᵢᵣ, where t is limited by the maximum number of threads Tᵣ per class r. A problem can occur with the traces, as the available information about the placement of threads may be insufficient. Hence, this can be addressed by applying a Monte Carlo Simulation, e.g., choosing random permutations of equation 477 with 1≦t≦Tᵣ and assigning them to queue t, 1≦t≦Tᵣ, before running FJ-AMVA. Then the average response time of 100 iterations can be determined, e.g., to produce stable results. Finally, the class routing probabilities pᵣ can be approximated, with pᵣ=1/lᵣ for the TP-AMVA implementation and pᵣ=Tᵣ/I for FJ-AMVA.

### Prediction of TPC-H Query Templates

### Prediction Scenarios and Methodology

At first, interest may exist for understanding the per-class prediction accuracy of TP-AMVA under different multi-programming levels, including 1, 4, 8, 16, and 32 concurrent users (Con). AMVA, FJ-AMVA and TPAMVA can be parameterized with system parameters of the IBM4 system, e.g., obtained from isolated query runs. Subsequently, the per-class response time for each of the R=22 TPC-H query templates can be predicted under concurrent workloads. Since each workload scenario can be defined by a class population vector, \vec{N}=N₁, . . . , N_{R} and a think time vector, \vec{Z}, the respective trace think times can be used for each concurrent user scenario (Conᵢ) and defined the population for class r as Nᵣ=Conᵢ.

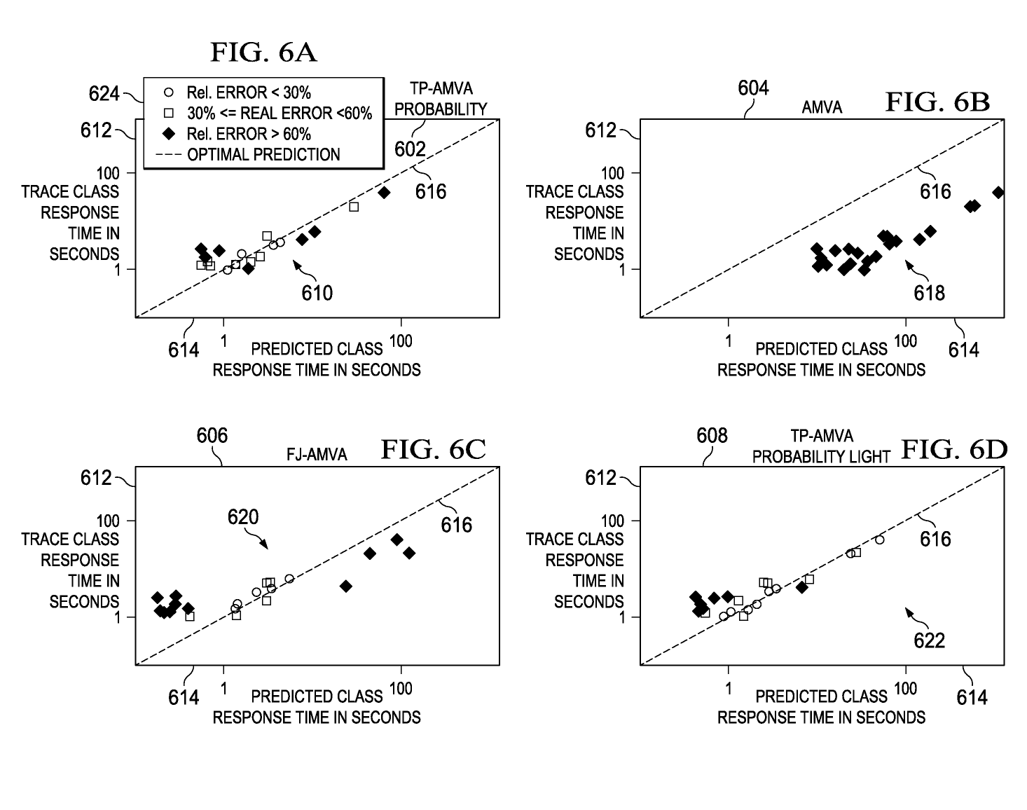

Due to the amount of workload scenarios across all prediction methods and query templates, only the trend of the per-class prediction accuracy may be of primary interest. In particular, one detailed example of how TP-AMVA, AMVA and FJ-AMVA predict single query templates can be examined. FIGS. 6A-6D show example comparisons of predicted per-class response times 614 relative to trace class response times 612. Specifically, FIGS. 6A-6D show comparisons 610, 618, 620, and 622, respectively, among per-class response times 612 from 8 user scenario on the IBM4 4-socket default NUMA Configuration (normalized by response times of class 1). As shown in FIGS. 6A-6D, the Cons scenario can be chosen and the predicted response times of each method can be plotted against the trace response times from Cons. As a reference, a straight line 616 in form of y=x is shown, which depicts an optimal prediction. For example, predicted class response times that fall above this line are optimistic, whereas those falling below this line are of a pessimistic character. A legend 624 identifies labeling used on the plots.

### Results

The results of the per-class prediction analysis are shown in FIGS. 6A-6D. In particular, note that TP-AMVA_{prob} predicts the majority of classes reasonably well and shows a slightly pessimistic behavior for most of the remaining query templates. TP-AMVAₛₜₐₜ is not included, since it shows similar, slightly more pessimistic results than TP-AMVA_{prob}. Looking at the extension TP-AMVA_{prob util} in scatter plot in FIG. 6D, it is noted that this load-dependent modification of AMVA performs best. In contrast, the standard AMVA implementation, given by the second scatter plot in FIG. 6B, tends toward a strong pessimistic prediction behavior, as it does not account for the variable threading level in each query template. For AMVAᵥᵢₛᵢₜ, it is observed that predictions were very optimistic, which indicates that the parameterization with the scaled service times does not improve prediction accuracy over AMVA. Interestingly, FJ-AMVA shows a diverse prediction character. On one hand, pessimistic predictions can be explained due to the summation term in the FJ-AMVA equation that produces higher response times for queries with high parallelism. On the other hand, optimistic predictions are caused by queries with low service times sᵢᵣ at each core, which are suspected to be due to the non-exponentiality in sᵢᵣ.

Similar results are observed for scenarios with 4, 16 and 32 concurrent users, and it is found that the per-class prediction accuracy across all methods is slightly decreasing the more parallel users are active. This is imposed on the problem classes with high parallelism (class 1,19) and classes with long execution times (class 9,21), for which all methods produced pessimistic response times. Apart from AMVA, which typically results in pessimistic predictions, the optimistic predictions for short running classes can be explained due to strong contention effects, which are difficult to accurately capture by the considered methods. The reason for this in the traces can be determined to be in the form of extreme blocking that caused an increase of response times for short running queries by a factor of up to 1000 under Con₃₂ compared with Con₁.

### Sensitivity Analysis Under Different Hardware Configurations

Having shown that TP-AMVA outperforms other methods under per-class prediction scenarios, exploration can be done to determine if the technique can be used to predict mean response times under different in-memory database system configurations. Focusing can occur specifically on the three in-memory database systems IBM4, IBM8 and HP8, introduced above, and a sensitivity analysis can be conducted to evaluate the robustness of the approximation along two different dimensions. At first, changed can be compared in the response time prediction accuracy when increasing the number of virtual processing cores, from 32 (2 sockets) to 64 (4 sockets) and from 64 to 128 (8 sockets). Since the IBM4 system is limited to 64 virtual cores (Hyper Threading enabled), IBM8 is chosen as a reference system for this analysis. Second, the model performance can be examined across different hardware types. In that case, the number of sockets can be kept fixed to four, and the hardware type can be varied from IBM4 to IBM8 and HP8. The workload scenarios can be considered from the traces with 1, 4, 8, 16 and 32 parallel users (Con_{1, . . . , 32}). Since the times in the traces are increasing with the number of parallel users, e.g., due to the sequential execution order of TPC-H query sets chosen by, the respective trace think times can be used for each workload scenario. In addition, the mean response time W can be determined based on the per-class throughput ratios as shown in equation 409, where the system throughput X is obtained as sum over all per-class throughputs Xᵣ. Due to confidentiality, the results can be normalized by the trace response time from Con1 on the IBM8 4-socket configuration.

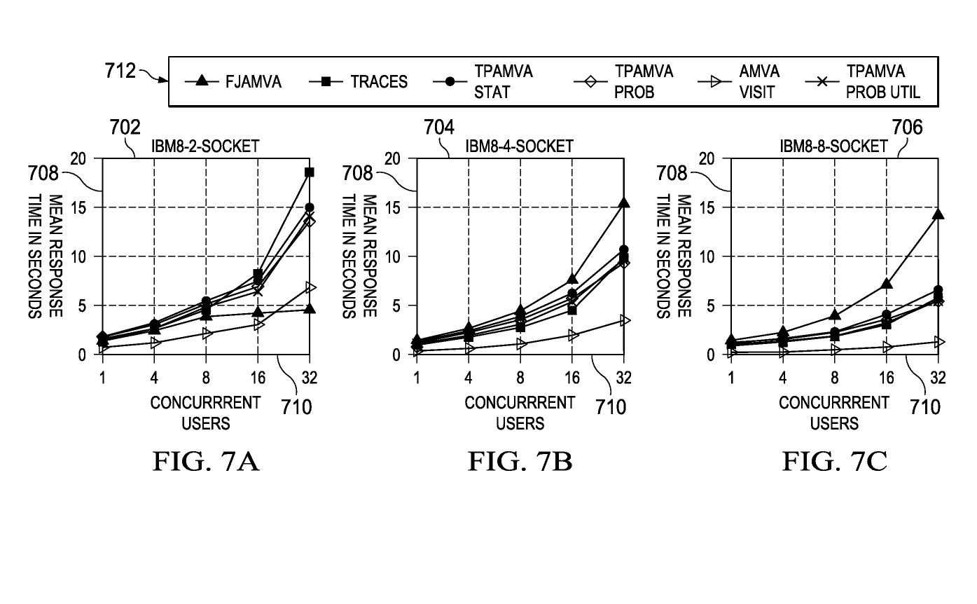

FIGS. 7A-7C show example mean response times 708. For example, FIGS. 7A-7C show predicted response times across different NUMA configurations on the IBM 8-Socket System (e.g., normalized by response times from 4-Socket Con1 scenario on IBM8). The first analysis are shown across the dimension of varying number of processing core/sockets in FIGS. 7A-7C, for 2-, 4- and 8-socket scenarios 702, 704, and 706, respectively. From the trace results, a different performance can be observed across all three system configurations, which can be imposed on the number of available sockets. One question that can be raised is how the analytical approximations can cope under these scenarios. Surprisingly, all three TP-AMVA variants can be able to capture contention effects very accurately across all IBM8 configurations. While TP-AMVAₛₜₐₜ and TP-AMVA_{prob} show a slightly pessimistic character under up to 8 concurrent users 710, TP-AMVA_{prob util} can capture contention under light load scenarios slightly better. This suggests, that the contention model in equation 408 improves accuracy notably. FJ-AMVA predictions tend to get more pessimistic the more parallel users are active. The reason for this can be found in the response times for query classes 1, 9, 19 and 21, all with distinct characteristics difficult to capture. Furthermore, poor results can be observed for FJAMVA under the 2-socket scenario, but this can be attributed to skewed sub-service times in the traces for this configuration. Both AMVA approximations may perform poorly, since they either neglect threading levels, which can be the reason to exclude the strong pessimistic results of AMVA, or scaled service demands can be used resulting in very optimistic response times for AMVAvisit. A legend 712 identifies labeling used on the plots.

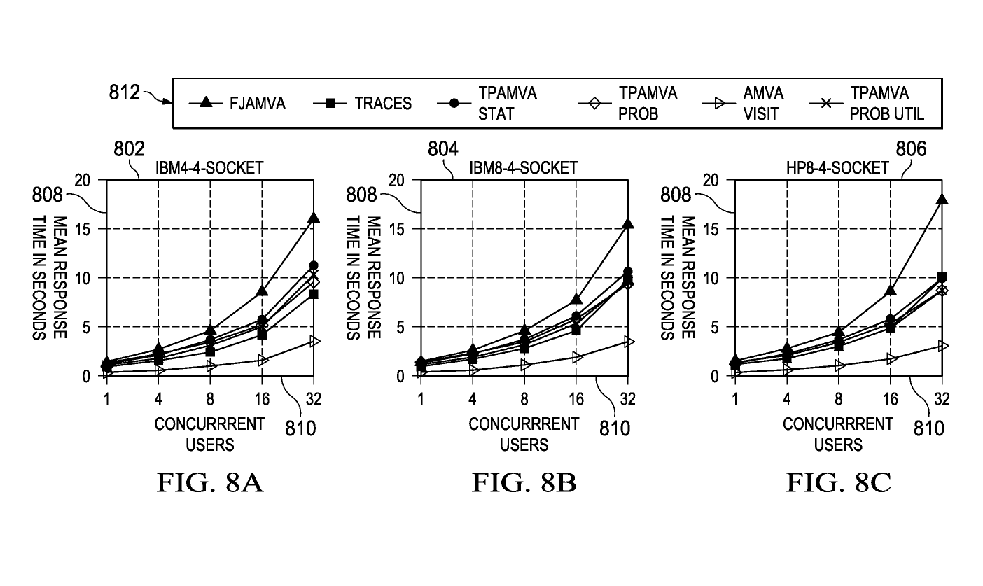

FIGS. 8A-8C show example predicted response times 808 across different hardware types. For example, the predicted response times across different hardware types are with 4 Sockets (e.g., normalized by Response Times from 4-Socket Con1 Scenario on IBM8). The results of the second analysis across different hardware types, for example, are presented in FIGS. 8A-8C, for 2-, 4- and 8-socket scenarios 802, 804, and 806, respectively, for different numbers of concurrent users 810. In general, a similar behavior can be observed for each method with respect to all three system configurations. This suggests that varying the hardware type has only little impact on the predictive capabilities. A legend 812 identifies labeling used on the plots. The relative prediction errors are further reported across all scenarios in Table 2: cross all scenarios in Table 2: cross all scenarios in Table 2:

TABLE 2
Relative Error of Mean Response Time Prediction compared
with Mean Trace Response Times

Virtual Processing Cores

| | |
|---|---|
| IBM8 | IBM4HP8 |

| Method | 32 | 64 | 128 | 64 | 64 |
|---|---|---|---|---|---|
| TP-AMVA_{prob util} | 0.13 | 0.09 | 0.04 | 0.19 | 0.05 |
| TP-AMVA_{prob} | 0.21 | 0.21 | 0.15 | 0.27 | 0.16 |
| TP-AMVAₛₜₐₜ | 0.19 | 0.26 | 0.22 | 0.37 | 0.17 |
| FJ-AMVA | 0.32 | 0.57 | 1.03 | 0.81 | 0.60 |
| AMVAᵥᵢₛᵢₜ | 0.57 | 0.63 | 0.78 | 0.63 | 0.68 |
| AMVA | 3.55 | 6.39 | 11.00 | 7.48 | 6.16 |

From the results, it can be observed that that TP-AMVA_{prob util} notably improves TP-AMVA_{prob}, falling below a 20% error across all system configurations. While TP-AMVA_{prob} and its static pendant still retain a high accuracy, FJ-AMVA predictions are too inaccurate under high load scenarios, whereas the high relative error for both AMVA variants clearly shows that both methods cannot capture contention effects properly.

From the results of the per-class evaluations and the sensitivity analysis, a conclusion can be made that AMVA, AMVAᵥᵢₛᵢₜ and FJ-AMVA, in their proposed form, are less suitable for modeling OLAP-based query workloads. The correction, however, turns out to be reasonably accurate and, due to its simplistic model, a good choice for the optimization program presented in the next section.

### Optimizing Workload Placement

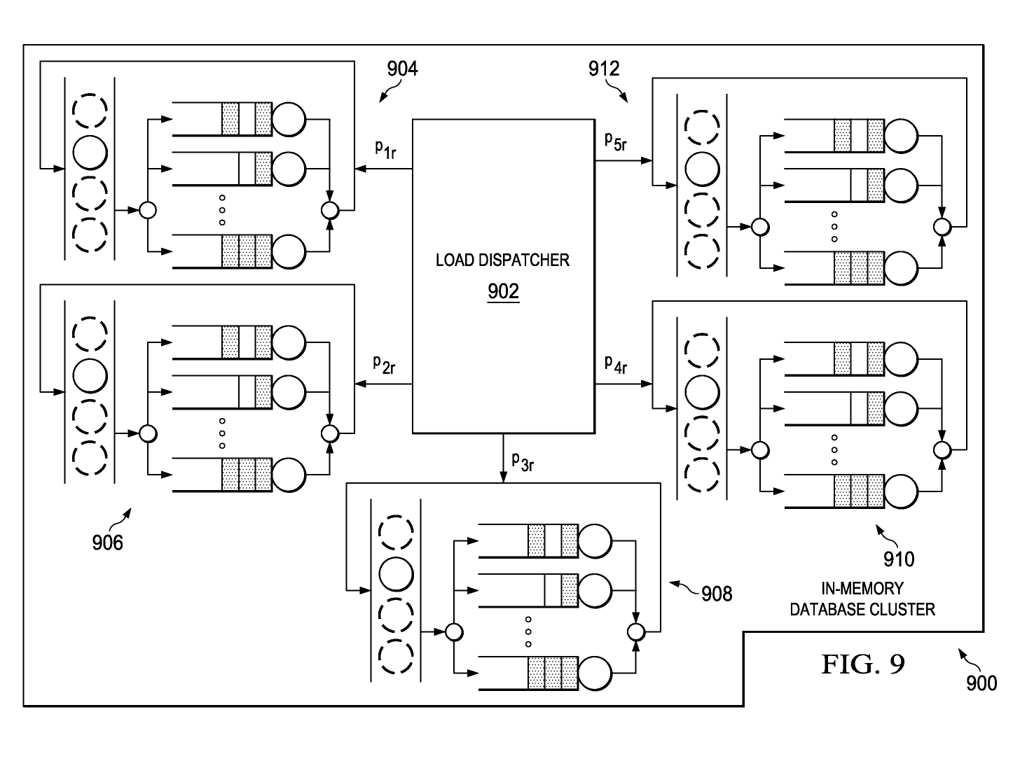

The optimization methodology can aim at solving the challenge of placing analytical workloads on in-memory database clusters in a way that improves a particular objective, e.g., response times, throughputs or memory occupation, subject to given SLO and resource constraints. To represent such a cluster, an aggregation of database servers is considered, each modeled by a multi-class closed QN that share a common load dispatcher 902, as detailed in FIG. 9. FIG. 9 shows an example model of an in-memory cluster subject to load optimization. Consequently, as shown in FIG. 9, the workload population \vec{N} can be shared amongst all servers 904-912, where each server maintains the same dataset locally or is connected to a shared high speed storage back-end. Recall that analytical workloads are read-only, and thus the dataset location has no impact on the cluster performance after datasets have been loaded into main memory.

Since an interest exists in the question of how jobs should be routed from the load dispatcher 902 to each server 904-912, optimal workload routing probabilities are sought. Hence, for the optimization model, pᵢᵣ, can be designated as the probability of routing a class r request to server i. Also, Nᵢᵣ=Nᵣ×pᵢᵣ, 1≦i≦K can be defined as the percentage of workload that goes to server i. The next section shows how to model the workload routing problem with an appropriate optimization-based formulation.

### Non-Linear Optimization Strategy

### Queueing Predictive Functions

Optimization-based formulation is presented in equation 410. The objective F is generic and can include, but is not limited to, the minimization of memory consumption, response times or TCO, as well as maximization of query throughputs or resource utilization. The objective can be minimized by seeking routing probabilities pᵢᵣ that allow for near optimal workload placement, as explained in the equations 410a-410k

Equation 410a describes the generic objective function F that is to be minimized. The function parameters are called decision variables. A solver that minimizes F tries to find values for the decision variables that minimize F.

Since objective F is subject to certain constraints that need to be obeyed by the solver when searching for appropriate values of all decision variables, the constraints are explaining in the following sections. Note that in all equations the servers i are independent and only share the workload Nᵣ. There is no sharing of query subtasks between the servers. A query is dispatched in form of an atomic request to one of the servers, and only there is it further forked into subtasks. Under this assumption the equations are valid.

In equation 410b e.g., used as a constraint), Uᵢ represents the utilization of each in-memory database server i. For each server I, the utilization is obtained by a summation over the products of per-class throughput Xᵢᵣ at server i and the per-class service demands dir. The term lᵢᵣ/Iᵢ is a modification that helps to represent the utilization for each multi-core server with a single queue instead of using multiple-queues (see also the description for equation 405). Equation 410a is equal to equation 405 when there is only one server.

In equation 410c (e.g., used as a constraint), Nᵣ denotes the total number of class-r query jobs that are to be submitted to the cluster. Nor is the portion of Nᵣ that goes to server i, obtained by multiplying Nᵣ with the load-dispatching probability pᵢᵣ.

Equation 410d is a constraint that provides a standard queueing relation. The number of class-r jobs Qᵢᵣ that are queueing at a server i is determined by the product of per-class throughput Xᵢᵣ and the response time Wᵢᵣ.

Equations 410e, 410f and 410g are used for a queueing model with a fixed point iteration. For example, the discussion that follows provides a short overview of how a queueing model 400 depicted in FIG. 4A is solved. Solving such a queueing model includes: the workload specification (per-class jobs 456 Nᵣ, per-class think times 454 Zᵣ), the queueing model parameterization with service demands dᵣ and the per-class thread-/fork-level information lᵣ, and finally the computation of the three performance measures queue length Qᵣ, throughput Xᵣ and response time Wᵣ. The general algorithm used to solve a queueing model without a fork join (e.g., with just a single queue) is using a fixed-point iteration. This involves the following steps. Qᵣ is initialized with Qᵣ=Nᵣ. Then a fixed-point iteration can be run, e.g., as shown in pseudo-code 405p.

For each class r, this algorithm computes Wᵣ, Xᵣ and Qᵣ. Then a check is made if Qᵣ has changed: if yes, then a second iteration is done computing Wᵣ, Xᵣ and Qᵣ again. The algorithm stops when Qᵣ is not changing anymore.

The difference in this case is the use of a new response time approximation (equation 406) instead of the standard equation 405b (equivalent to equation 401). How equation 405b works is explained above. A new contribution that extends equation 405b is provided above for equation 406.

The main difference here is a modification of the per-class response time Wᵣ by multiplying the per-class queue length Qₛ with the fork-level ratio of each class (lᵣ/I) (per-class fork-level lₛ over the number of available processing cores I in the in-memory database server 452). In addition, the queue length Qₛ is multiplied by the contention probability pᵣₛ, that further changes the queue length based on the likelihood of query interference. Equations 407 and 408 account for this likelihood.

This section describes how to solve a queueing model with a constraint solver. When it is desired to integrate the analytical technique into an optimization program, a fixed-point iteration cannot be used. The important point to understand here is that as described above, the queueing model is solved by computing Wᵣ, Xᵣ and Qᵣ. Since all three performance measures depend on each other (see fixed-point iteration), two degrees-of-freedom are encountered. That means knowing any two of the three measures Wᵣ, Xᵣ and Qᵣ allows computation of the third value. Consider an algorithm that arbitrarily searches for values of Wᵣ and Xᵣ and subsequently determines Qᵣ as Qᵣ=Xᵣ Wᵣ. In this case the queueing model can be solved without a fixed-point iteration. This allows a free selection of values for Xᵣ and Wᵣ and for computing Qᵣ. However, the choice of values for Xᵣ and Wᵣ is constrained, since one cannot choose any value for the two parameters without violating the queueing network relations. This means the algorithm that searches for values of Wᵣ and Xᵣ has to make sure that equations/constraints (equations 410e, 410f, 410g) are not violated when choosing values for Wᵣ and Xᵣ. These three constraints basically guide the search for appropriate values for Wᵣ and Xᵣ and to be precise, there exists only one possible value for Wᵣ and one possible value for Xᵣ, so that the constraints (equations 410e, 410f, 410g) are not violated. Once the algorithm has found these values for Wᵣ and Xᵣ, it computes Qᵣ=Xᵣ Wᵣ, providing a solution of our queueing model without having used a fixed point iteration. The algorithms that are typically used to solve such a problem are non-trivial and make use of the Interior-Point method.

Equation 410e is one of the constraints that guide the search for values of Xᵣ and Wᵣ in order to independently solve the queueing model for each of the in-memory database servers in the in-memory database cluster. Deriving equation 410e is straightforward. This constraint is obtained by substitution of equation 410d. It is a necessary equation that brings all three performance measures queue length Q, throughput X and response time W into one constraint. The constraint can be obtained by the substitution chain shown in equations 406a-406e in which equation 406a is reformatted to equation 406b, and equation 406e is determined by substituting equations 406c and 406c into equations 406d.

Simplifying equation 406e, adding the i subscript to account for i=1 . . . K servers and adding the summation signs leads to equation 410e described above. Equation 410f is a standard queuing relation.

Equation 410g is a constraint that ensures that the response time chosen by the optimization algorithm is at least as big as the service demand dᵢᵣ, the time it requires to serve query r at server i (without queuing).

The optimization program does not only solve the queueing model (by searching appropriate values for Xᵣ and Wᵣ described above), but at the same time it searches for the load-dispatching probabilities pᵢᵣ, which are different from the contention probabilities in equations 407 and 408. Combining the search for load-dispatching probabilities with the formulations that describe the solution of a queueing model (e.g., using equations 410b, 410d, 410e, 410f and 410g) works because for each value that an optimization solver chooses for pᵢᵣ there is only one possible solution for Wᵢᵣ and Xᵢᵣ. Thus the solver tries to search for a pᵢᵣ that minimizes the objective function F. Again the choice of values for pᵢᵣ is constrained. This requires the added constraint 10h:

Equation 410h is a constraint that ensures that the number of jobs for each class r are split correctly among the servers i, e.g. it avoids sending 100% of the workload to server 1 and 100% to server 2.

Equation 410i is a constraint that ensures that the load-dispatching probabilities, throughputs and response times are greater than or equal to 0.

Equation 410j is a constraint that ensures that each server i gets at least one job per class r, since queueing relations are not defined for a zero per-class population Nᵣ=0.

Equation 410k is an example for a resource constraint. When searching for optimal load-dispatching probabilities the solver has to make sure that the utilization of server i must not exceed a predefined maximum utilization.

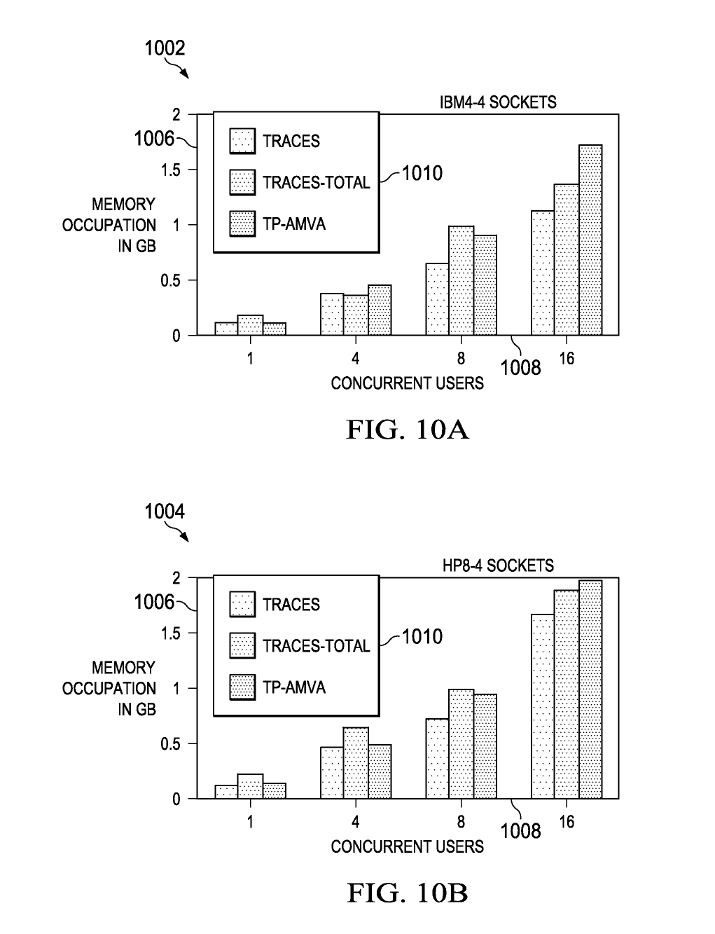

Next to the advantage of the methodology, being able to handle a variety of objectives, one important part are the queueing predictive functions, which can be integrated in form of TP-AMVA in FIGS. 10B to 10G. A problem that is to be overcome is to choose the right tradeoff between suitability for nonlinear optimization and complexity/accuracy of the three TP-AMVA expressions. Since both probabilistic versions of TP-AMVA performed best, a common approach can be followed that employs the less complex expression, TP-AMVA_{prob}, for the main optimization part, and a final optimization run can be conducted with the more complex but also more accurate approximation, TP-AMVA_{prob util}. This can be necessary, since TP-AMVA_{prob util} can cause longer optimization times due to its additional contention expressions. However, this overhead is quantified below, including showing that TP-AMVA_{prob util} could still be used solely in small/medium scale optimization scenarios.

Further, δᵢᵣₛ=(Nᵢᵣ−1)/Nᵢᵣ×(lᵢᵣ/Iᵢ) can be defined for s=r and δᵢᵣₛ=1 in case of s 6=r. This can account for the Bard-Schweitzer approximation as well as the probabilistic expression of TP-AMVA, both introduced above. Further, a minimum workload of 1 job can be set per class per server (equation 410j), since the solution of queueing models for Nᵣ<1 is not defined. In addition, utilization constraints can be added in form of Uᵢ^{max} and correct routing probabilities can be ensured with (equation 410h). From a performance point of view, the method can use less variables compared with FJ-AMVA, which would introduce at least (I−1)K×R additional binary variables to sort the response times for I processing cores, K servers and R classes. Since the optimization problem is nonconvex, the number of local optima can be expected to grow when increasing the number of classes and servers as well as introducing different constraints for each server. This can exacerbate the problem of finding a globally optimal solution and can require strategies such as multi-start optimization.

### Minimization of Memory Occupation

The generic methodology can be applied to an important optimization problem that considers the minimization of memory consumption to prevent memory exhaustion and potential swapping in in-memory database clusters. The ease of integrating an additional memory occupation model into the optimization-based formulation can also be demonstrated. To represent the above optimization problem, for example, the objective function shown in equation 411 can be chosen, which minimizes the total sum of per-server memory occupation Mᵢ for K in-memory database servers. Since this requires a model to estimate Mᵢ, a new memory occupation estimator of the following form can be developed, as shown in equation 412 and the estimator can be added to the constraint set of the optimization program. In particular, for server i, Mᵢ can be estimated by multiplying the per-class mean queue length Qᵢᵣ of each class r with the per-class physical peak memory consumption mᵣ that is recorded in the trace logs for that class. A conservative assumption can be made that memory occupation grows as a function of Qᵢᵣ and the idea that query classes could share data residing in main memory can be neglected. Additionally, it can be assumed that forking of jobs and joining are not related to the change of memory consumption. Finally, the constraint Mᵢ≦Mᵢ^{max}, ∀i can be added that allows the control of memory exhaustion with Mᵢ^{max} defining the memory threshold up to which servers are allowed to be exhausted.

### Evaluating the Memory Occupation Model

Before evaluating the optimization program in the next section, a short analysis of the memory occupation model (equation 412) is provided, the main part of the minimization objective in equation 411. The evaluation can include predicting the peak memory occupation with TP-AMVA_{prob light} under concurrent workloads with 1 to 16 parallel users and a comparison with the actual physical peak memory recorded in the traces.

FIGS. 10A-10B show graphs 1002 and 1004 of example predicted peak memory occupations 1006 under multi-user scenarios. For example, the predicted peak memory occupations 1006 under multi-user scenarios are normalized by the “Traces-total” value from user scenarios described with reference to FIGS. 8A-8C. FIGS. 10A-10B show the peak memory occupation from the traces based on the counted per-class queue lengths Qᵣ multiplied with the per-class peak memory mᵣ as Pᵣ Q^{counted}ᵣ×mᵣ (Traces). The total peak memory recorded from the Linux/proc/<pid>/status file (Traces-total) and the peak memory predicted by TP-AMVA via Pᵣ Q^{TPAMVA}ᵣ×mᵣ (TP-AMVA) can also be included. Ideally, the value for the method ‘Traces’ and ‘Traces-total’ should be the same. A legend 1010 identifies markings used on the graphs, e.g., related to bars for ‘Traces,’ ‘Traces-total,’ and ‘TP-AMVA.’ This behavior can be seen in the similar results on the IBM and HP configuration, which suggests that the approximation in equation 412 is reasonably accurate. Furthermore, the gap under 8 and 16 concurrent users 1008 can be attributed to outliers caused by the limited trace length of 1 hour. In addition, the difference between ‘Traces’ and ‘TP-AMVA’ under Con₃₂ can be explained by the predicted queue length for query class 21. More specifically, it can be found that class 21 causes the highest memory occupation, as shown in FIG. 3C, which thus leads to big changes in the peak memory for small increases in Q. However, it can be observed that the queue length predicted with TP-AMVA_{prob light} gives a pretty good overall estimate of peak memory occupation in combination with equation 412, keeping in mind that it is generally difficult to handle outliers in an MVA framework without probabilistic measures.

### Numerical Evaluation

This section focuses on exploring the optimization problem given in equation 410. Hence, the number of server instances K and classes clusters R in K,R=4, 8, 16 can be varied. In particular, k-means clustering can be employed in order to reduce the set of 22 TPC-H classes to a suitable number of clusters for the optimization process. A section below that describes the effects of class clustering provides a more detailed analysis of prediction errors under class clustering. Furthermore, the reference workload can be defined based on 22 classes in N=176K (light load, 8 concurrent users x 22 classes) and N=352K (heavy load, 16 concurrent users). Class cluster populations Nᵣ can be obtained by splitting N across all class clusters depending on the amount of queries falling into a cluster. Finally, memory constraints can be used to affect the workload placement: Mᵢ^{max}=512 GB for i≦K/2 and Mᵢ^{max}=256 GB for i>K/2.

### Evaluation Methodology—Solution Methods and Evaluation Approach

The minimization of memory swapping can be compared for two interior point based local search methods fm (Matlab's fmincon) and ip: (IPOPT, or interior point optimizer), shipped with the OPTI Toolbox. A selection of fm and ip can be made because the optimization based formulation includes non-linear constraints. In some implementations, different global solvers can be used to provide a lower bound on the optimization problem, e.g., bilinear matrix inequality branch-and-bound (BMIBNB) or Solving Constraint Integer Programs (SCIP, provided by Zuse Institute Berlin). Their use can allow the computation of an optimality gap for fm and ip. The approaches can be implemented in MATLAB using the modeling language YALMIP. The scenarios can be evaluated on an Intel Core i7 CPU with 2.40 GHz and 8 physical cores. To cope with different local optima, P=50 initial points can be randomized for every tuple (K,R,N/K), and fm and ip can be run using a multi-start implementation. In addition, the mean execution time and its standard deviation can be reported across all P local solver runs. More specifically, the YALMIP processing overhead can be excluded, and only the actual solver time spent by fm and ip need be reported. A timeout of 1800 seconds can be further set to understand the performance at short time scales.

### Motivation for Multi Start Based Approach

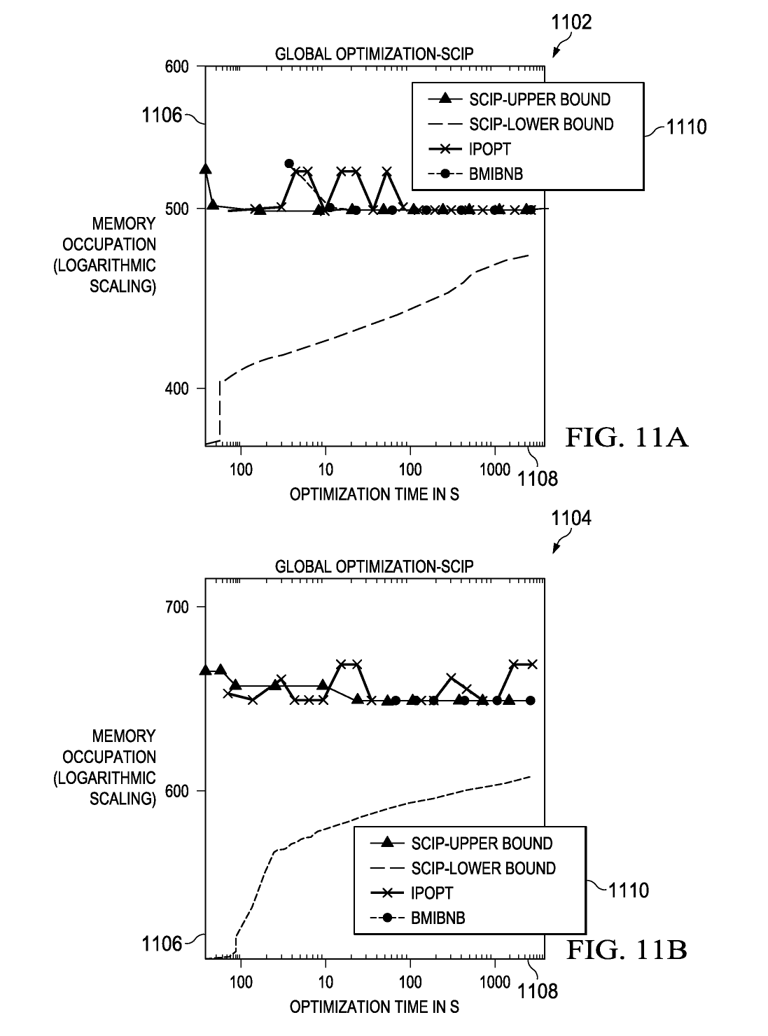

Since global optimization can quickly become intractable, the local solver ip can be employed to explore how large the gap between solutions of the multi-start based local solvers compare with global solvers. FIGS. 11A-11B show example scenarios 1102 and 1104 of global optimization, e.g., memory occupation 1106 versus optimization time 1108. A legend 1110 identifies markings used on the graphs, e.g., related to bars for SCIP—upper bound, SCIP—lower bound, IPOPT, and BMIBNB. As shown in FIGS. 11A-11B, global optimization can be stopped after a 6% duality gap is reached. During analysis, for example, two different scenarios can be chosen, and each scenario can be run until an optimality gap of 6% is reached. For both scenarios, the upper bound can be minimized very quickly. This eliminates the need for many iterations to achieve a good solution, which in worst case could only further improve by 6%. The difficulty of further reducing the optimality gap can be imposed on the large search space spanned by the decision variables. However, the results can suggest that the optimization problem is of such a form that reducing the optimality gap further would have only little impact on the actual improvements. Thus, the results can be a strong indicator for preferring a multi-start approach based on IPOPT. It also can be determined that BMIBNB takes longer to converge than SCIP, due to its additional processing overhead. Hence, for the following evaluation scenarios, SCIP can be used to provide a lower bound and IPOPT to determine an upper bound on the optimization problem.

TABLE 3
Memory Occupation and Optimality Gap^{†}.

| Inst. | | Memory (GB) | | Gap (%) | | Max Mem. | |
|---|---|---|---|---|---|---|---|
| K | R | fm | ip | fm | ip | fm | ip |

Light Load, N = 176K

| | | | | | | | |
|---|---|---|---|---|---|---|---|
| 4 | 4 | 173.05 | 170.72 | 1.71 | 0.37 | 174.89 | 171.22 |
| 4 | 8 | 181.98 | 181.98 | 2.91 | 2.91 | 187.71 | 182.70 |
| 4 | 16 | 183.62 | 183.62 | 8.73 | 8.73 | 189.95 | 184.39 |
| 8 | 4 | 333.58 | 333.58 | 5.34 | 5.34 | 370.58 | 338.62 |
| 8 | 8 | 355.22 | 354.78 | 9.05 | 8.94 | 419.30 | 355.16 |
| 8 | 16 | 363.09 | 357.75 | 11.57 | 10.25 | 364.20 | 357.75 |
| 16 | 4 | 659.59 | 659.59 | 7.30 | 7.30 | 772.08 | 668.93 |
| 16 | 8 | 712.73 | 702.90 | 11.70 | 10.46 | 714.48 | 705.08 |
| 16 | 16 | 719.87 | 709.13 | 12.17 | 10.84 | 719.87 | 711.04 |

HeavyLoad, N = 352K

| | | | | | | | |
|---|---|---|---|---|---|---|---|
| 4 | 4 | 489.12 | 489.12 | 2.20 | 2.20 | 763.21 | 626.91 |
| 4 | 8 | 512.13 | 512.13 | 13.04 | 13.04 | 585.47 | 577.75 |
| 4 | 16 | 514.46 | 512.55 | 19.08 | 18.78 | 668.65 | 586.53 |
| 8 | 4 | 795.67 | 795.67 | 15.67 | 15.67 | 1196.21 | 808.32 |
| 8 | 8 | 920.52 | 912.14 | 26.08 | 25.40 | 1115.73 | 925.11 |
| 8 | 16 | 932.14 | 923.86 | 27.85 | 27.20 | 960.67 | 939.01 |
| 16 | 4 | 1568.28 | 1568.28 | 21.38 | 21.38 | 1575.04 | 1728.64 |
| 16 | 8 | 1949.40 | 1772.82 | N/A* | 24.77 | N/A* | 1902.88 |
| 16 | 16 | N/A* | 1805.46 | N/A* | 26.01 | N/A* | 1810.06 |

^{†}Gap between best solver solution and lower bound of SCIP
*No solution found within given timeout of 1800 s

### Results

### Minimization of Memory Occupation

The results of the analysis are presented in Table 3. Observe that the methods fm and ip produce similar results regarding the memory occupation M for instances up to 8 servers and 4 classes. This can be explained due to the same algorithm being used to solve the queueing models. However, fm can be deficient under scenarios with more than 8 servers and 8 classes, which can be attributed to the increased optimization time fm requires to converge to a local optimum. Upon examination of the variability across found solutions, the worst local optimum found by fm and ip can be recorded in the rightmost columns of Table 3. Under both light and high load, differences are noticed between the best and worst found solution of up to 16% under low load (K=8,R=8) and 36% under high load (K=4,R=4). The higher gap under heavy load scenarios can be attributed to the increased workload that introduces more possibilities of being distributed amongst all servers.

The optimality gap can also be determined between the best found solution of the methods fm and ip compared with the lower bound found by SCIP in form of |m−SCIP_{lower}|/m×100, where mε{fm,ip}. For example, under light load, the possible improvements of solutions found by fm and ip fall below 13%. Under heavy load, the difficulty of finding a global solution rises. This can be observed through an increase of the optimality gap for ip by a factor between 2.15 (4,16) and 5.95 (4,4) compared with the respective light load scenario.

### Optimization Times

To get an idea about the complexity of the optimization problem, the mean optimization times can be determined across all multi-start runs for fm and ip together with their respective standard deviations in Table 4:

TABLE 4
Optimization Times in seconds^{†}.

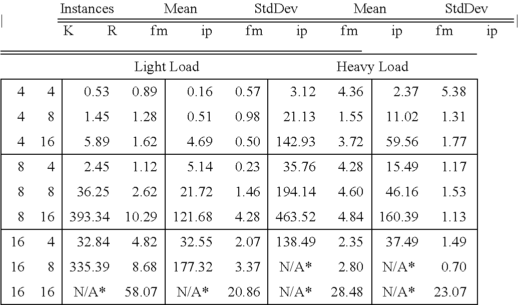

^{†}Mean optimization time across all multi start runs
*Optimization time exceeded the given timeout of 1800s

A large gap in mean optimization times between fm and ip can be identified, which can be due to the fast C++ implementation of IPOPT. Also note that for method fm, high load scenarios may seem to be more difficult to solve, since utilization and memory constraints are more likely to be violated. Furthermore, fm can be found to be unable to complete a single run within the given timeout of 1800 seconds for instances with 16 servers and 8 classes under low load as well as 8 and 16 classes under heavy load. In contrast, ip can retain short optimization times, more or less independent from the actual load. This is why it is worth exploring the maximum number of servers that ip can optimize when limited to 4 customer classes. Such exploration can determine (and experimentation has determined) that instances up to 512 servers could be solved in under 1000 seconds per single run.

### Workload Placement

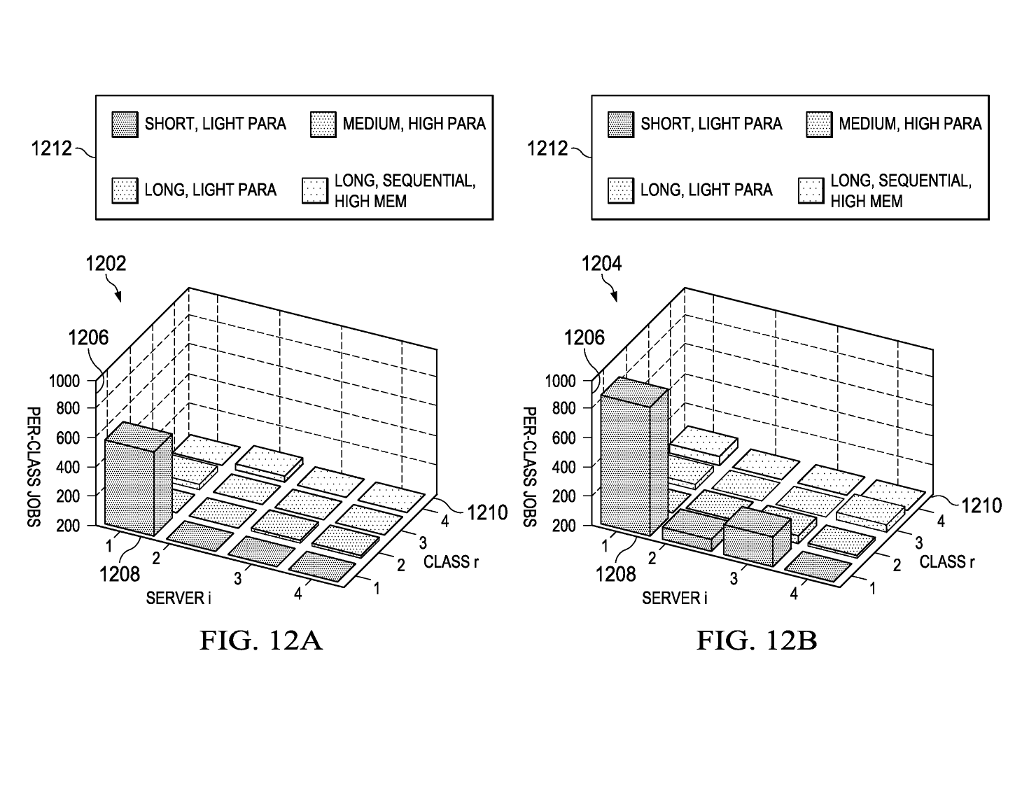

Another question to address is how the optimization program handles workload placement. Therefore, the instance with 4 servers and 4 classes under light and heavy load can be investigated. FIGS. 12A-12B show optimized placements 1202 and 1204, respectively, of workloads under light and heavy loads. For example, FIGS. 12A-12B show the workload distribution obtained with method ip after optimization, as well as the query characteristics regarding service demand and parallelism. Specifically, per-class jobs 1206 are shown for combinations of server 1208 and class 1210. Under light load, server 2 uses 125 GB, whereas the other servers show a memory occupation of ≈15 GB, meaning no constraints are violated. However, the heavy load situation looks different. The memory bound portion of the workload (class 4) is now dispatched to servers with a memory constraint of 512 GB, in this case server 1 (using 340 GB), since server 3 and 4 are limited to 256 GB. Also note that under light load, as shown in FIG. 12A, classes with higher memory occupation, such as classes 2 and 4, are placed in a way that minimizes interference with other classes, e.g., class 4 on server 2, and class 2 on server 3 and 4. Note that at least one job per class is placed on each server, since closed queueing networks are not defined for Nᵣ<1. Under heavy load, resources on server 2 to 4 are fully utilized. The effect that is observed is that the class with the highest memory occupation (class 4) is isolated on server 1 and collocated with a class of lowest impact (class 1) due to the remaining workload that cannot be handled by server 2 to 4. From this a conclusion can be made that the optimization program handles resource constraints appropriately.

### Optimization Refinement and Validation

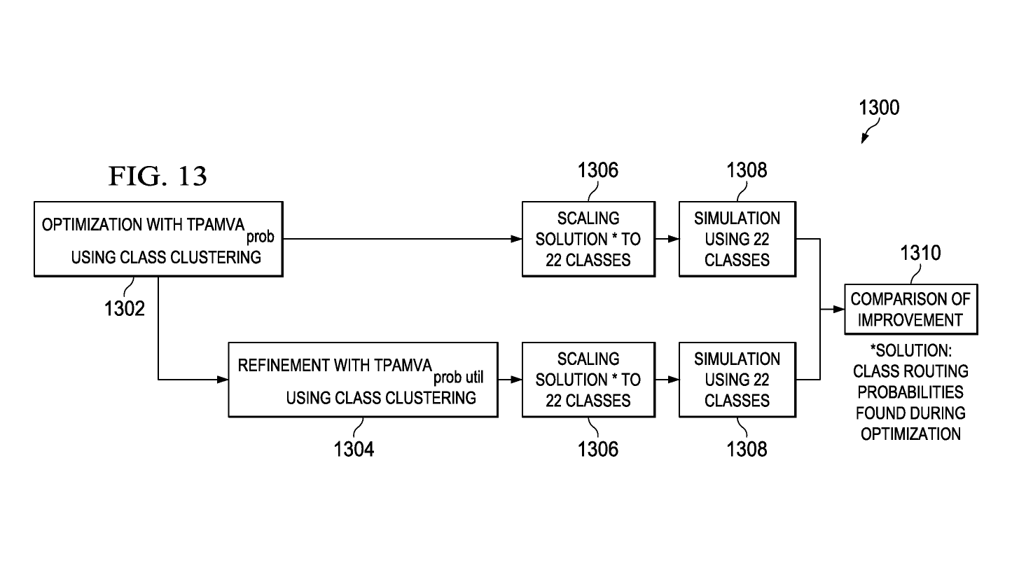

The optimization results can be further refined as mentioned above. FIG. 13 shows an example methodology for optimization refinement and evaluation against simulation. For example, the methodology detailed in FIG. 13 can be used to better understand this refinement step. In particular, the best solution is taken that is found by method ip based on TP-AMVA_{prob} as a starting point for a final run with TPAMVA_{prob util}. The class clustering applied during the optimization process (1302) can then be reversed, and the simulation can be used to quantify the actual improvement that can be achieved by a refinement run (1304) with TP-AMVA_{prob util}. Consequently, the optimal workload distribution can be determined using both TP-AMVA models, including using scaling and simulation steps 1306 and 1308, and each model can be used as input for a final simulation run in a comparison 1310. Then, computation can be made of the percentage of reduction in simulated memory occupation of TP-AMVA_{prob util} over TP-AMVA_{prob}.

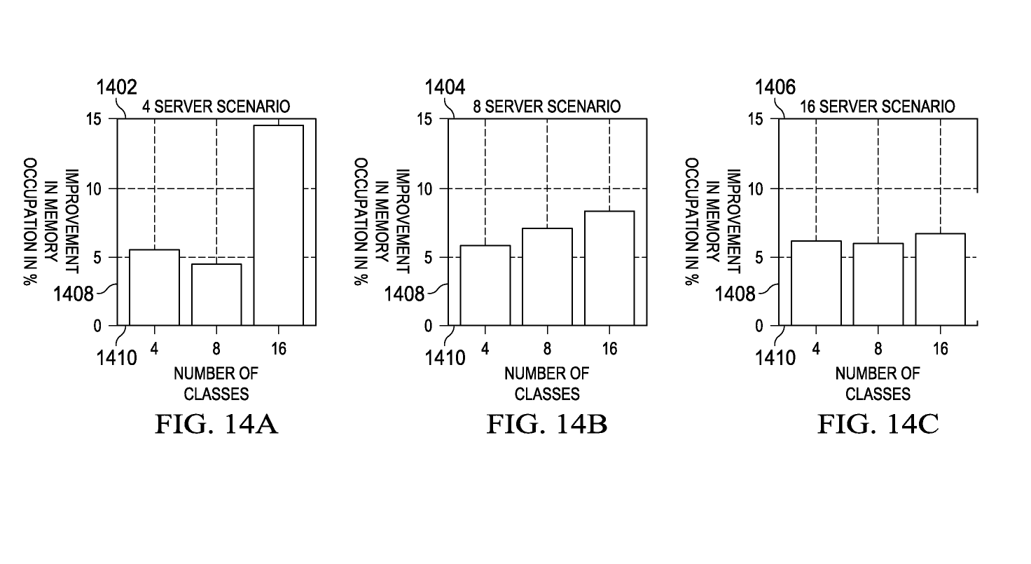

FIGS. 14A-14C show example improvements in simulated memory occupation.

For example, improvement in memory 1408 relative to a number of classes 1410 are shown for scenarios 1402, 1404, and 1406 having 4, 8 and 16 servers, respectively. The example improvements in simulated memory occupation are based on optimal workload placement found by TP-AMVA_{prob util} compared with TP-AMVA_{prob} as baseline. The results detailed in FIGS. 14A-14C are for the more relevant heavy load scenario. In fact, the refinement step reduces the simulated memory occupation by approximately 7% across all scenarios. This clearly works in favor for the approach. Admittedly, it is noted that experiments using TP-AMVA_{prob util} could slow down the solution process compared with TP-AMVA_{prob} by a factor up to 20 due to the associated additional nonlinear expressions. Nonetheless, TP-AMVA_{prob util} can still be used during the entire optimization process for scenarios up to 8 servers and 8 job classes. For larger scenarios with up to 512 servers however, a recommendation is to use TP-AMVA_{prob}, and if possible conduct a final run with TP-AMVA_{prob util}.

Summarizing the results, based on empirical evidence, the following results are identified. The optimization-based formulation multi-start based local search strategies achieve a good optimality compared with global solvers. Class aggregation can help to improve optimization times while retaining a reasonable level of accuracy, in particular in combination with TP-AMVA_{prob util}. The optimization methodology appropriately handles resource constraints under workload placement scenarios on in-memory database systems. Fast interior-point based methods, such as IPOPT, can be used for optimization scenarios up to 512 servers and 4 classes, before optimization times exceed the set timeouts.

### RELATED WORK

While more than a decade ago, research introduced fundamental cost models for the entire memory hierarchy in a database system, currently on-demand provisioning of these systems is driving research further into database optimization and encourages the use of queueing networks.

In some implementations, classification-based machine learning can be used to schedule tenants in multi-tenant databases. Tenant and node-level behavior can be characterized based on performance metrics collected from database and operating system layers, and the frameworks can be validated in a PostgreSQL environment. However, this approach may not consider variable threading levels and may put focus mainly on transactional workloads. Workload characterization and response time prediction via non-linear regression techniques for in-memory databases can be used. Tenant placement decisions can be derived by employing first fit decreasing scheduling, only evaluated on a small scale. Some frameworks can manage performance SLOs under multi-tenancy scenarios. For example, frameworks can combine mathematical optimization and Boolean functions to enable what-if analyses regarding service level objectives (SLOs), but this can rely on brute force solvers and may ignore OLAP workloads. In some implementations, three simple operational laws can be based on open queues. For example, analysis methods can apply to scaling decisions for multi-core network servers and can be validated on real HP systems. This method can depend on live-monitoring and can neglect job class information.

Optimization techniques can consider hardware and workload heterogeneity in cloud data centers to optimize energy consumption by dynamically adjusting allocated resources. Clustering approaches can be used to reduce large heterogeneous workloads with distinct resource demands in CPU and memory. Clustering approaches can also combine probabilistic expressions of an open queueing model with a mixed-integer optimization approach to solve provisioning problems. However, methodologies may require heuristics for finding a good solution. For example, query demands can be quantified by a fine-grained CPU-sharing model that includes largest deficit first policies and a deficit-based version of round robin scheduling. Methodologies can be applied to database-as-a-service platforms and can be validated, e.g., on a prototype of Microsoft SQL Azure. However, this approach may neglect characteristics for memory occupation. In some implementations, other frameworks can be used for non-linear cost optimization regarding SLA violations and resource usage. The frameworks can be applied to web service based applications and cloud databases. However, regarding per-class CPU resource cost, both approaches focus on service demands and CPU cycles, while neglecting variable threading of workload classes. For example, only the first 5 query templates of the TPC-H benchmark may be considered at small scale factors, whereas the workload characterization described herein illustrates the importance of the remaining queries and considers a scale factor of 100. In some implementations, a framework for multi-objective optimization of power and performance can be used. For example, the methodology can apply to software-as-a-service applications and can be validated using commercial software. The approach can be based on simulation and may not consider thread level parallelism.

### Prediction/Models

In some implementations, other prediction techniques and models can be used. For example, multivariate regression and analytical models of closed QNs can be used to predict query performance based on logical I/O interference in multi-tenant databases. However, these methods may require detailed query access patterns and evaluation may be possible only for small numbers of jobs and batch workloads. Other thread-level parallelism use similar techniques, but the approaches may be computationally expensive or may rely on exponential service time distributions. For example, probabilities can be used to model data and resource access conflicts in database systems to describe contention effects more accurately. However, this may not account for the extensive threading levels that occur in analytical workloads.

### CONCLUSIONS

Several aspects of analytic response time approximation are described above, including models of thread-level fork join and per-class memory occupation in in-memory systems. As described above, the models can exceed the accuracy of existing approaches using real traces from a commercial in-memory database appliances for validation. In addition, a generic and extensible optimization methodology is described that can be used to optimize workload placement for clusters of in-memory database systems in cloud infrastructures.

Some implementations, in addition to implementing a provisioning framework in a real in-memory database management system, can include modeling of resource contention under multi-tenancy, where client workloads are of transactional and operational characters or are based on differently sized datasets. Some implementations can focus on resource allocation challenges, such as optimizing CPU and memory resources for multiple co-located tenant databases on multi-socket systems in order to provide performance guarantees.

### APPENDIX

### A. Estimation of Service Demands for FJ-AMVA

This section provides a discussion of estimating service demands for FJ-AMVA, including how FJ-AMVA parameters are estimated. In addition to the core activity described above, traces can record the number of threads Tᵣ pertaining to a class r job execution process as well as the execution times of each individual thread, excluding the duration in which a thread was not active. This information may not be considered by convention approaches, and thus can necessitate the extraction of the information from the raw traces.

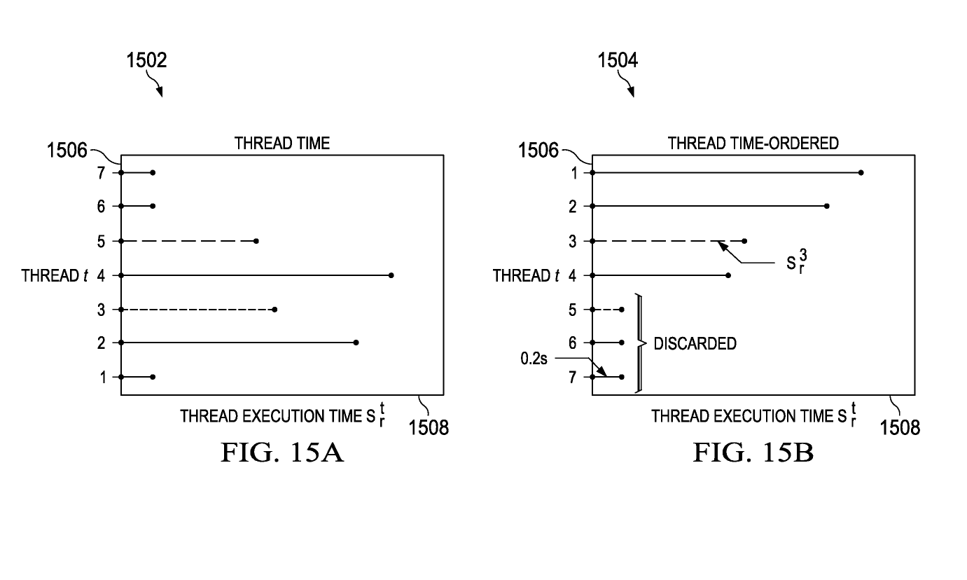

FIGS. 15A-15B show example service demand estimations for an OLAP query.

For example, the service demand estimation illustrated in FIG. 15A (e.g., in Case 2a 1502) lists all 7 threads 1506 that belong to an exemplary job, introduced above. The execution time 1508 of each thread t pertaining to a job of class r can be denoted with equation 476 and since FJ-AMVA specifically requires this representation, since equation 476 is used for its parameterization in experiments. Additionally, FJ-AMVA assumes that the number of per-class tasks Tᵣ is not bigger than the number of available processing cores I. However, for some classes and also for the example, with T=7 and I=4, this is not the case. Hence, equation 476 is sorted and only the first t≦I longest running threads are used, as shown in Case 2b 1504 (FIG. 15B). This is justified, as for the majority of classes in the traces, where the value of Tᵣ is given in equation 478. If a sampling interval of 0.2 seconds is used to collect the traces, for example, these threads can be ignored because their execution time falls under the sampling inaccuracy. A comparison of execution times can be made between Case 2a 1502 (FIG. 15A) and Case 2b 1504 (FIG. 15B) for thread times being un-ordered and ordered (e.g., equation 476 is sorted), respectively.

### B. Effects of Class Clustering

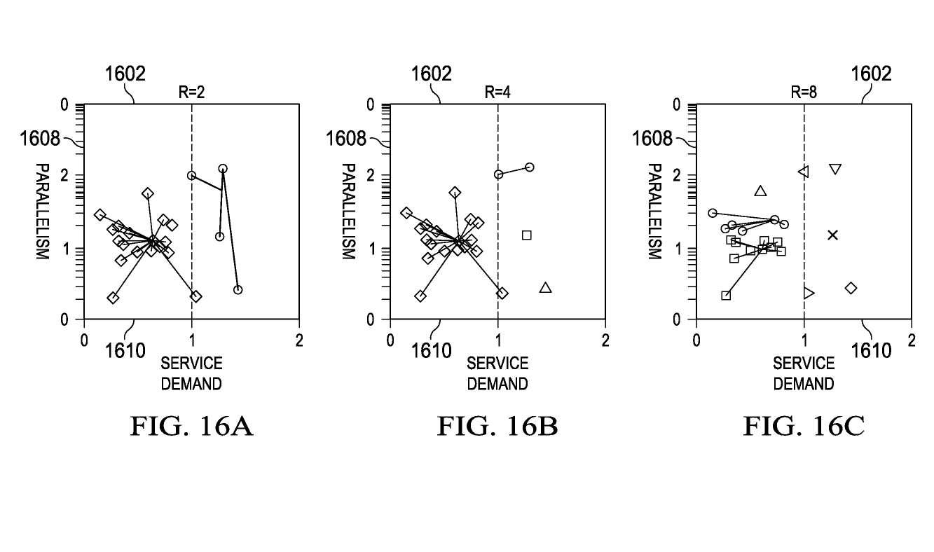

This section describes the effects of class clustering. As part of the evaluation of the optimization methodology described above, an additional analysis of the class clustering model is provided here. In particular, the analysis can consider how the performance measures of the queueing model, such as system utilization U, memory occupation M, mean response time W and system throughput X, are affected when parameterizing TP-AMVA with aggregated class parameters. To determine this, the set of R=22 TPC-H classes can be clustered with k-means (a priori normalized by z-score) across the two dimensions: parallelism lᵣ 1608 and service demand dᵣ 1610. FIGS. 16A-16C show example normalized query classes for different numbers of k-means clusters. For example, the clustering is depicted in FIGS. 16A-16C for the cluster sizes 1602 of C=2, 4, and 8, respectively, is shown using logarithmic scaling. This clustering approach can required the redefinition of the workload (\vec{N}, \vec{Z}), e.g., based on the original 22 class scenario with the number of per-class jobs defined by Nᵣ=Conᵢ and the total number of jobs defined by equation 479. Subsequently, the number of jobs per class cluster N_{c} can be estimated according to the frequency of each class occurring in a cluster, which in this case is N_{c}=P_{r,rεc}Nᵣ. In addition, the per-cluster think times Z_{c} can be estimated under consideration of response time laws, e.g., using the trace throughputs and response times from Conᵢ, as shown in equation 413, where c_{size} denotes the number of classes falling into class cluster c.

The relative error of TP-AMVA_{prob} under class clustering compared with a reference run can be determined using 22 classes under workload scenarios with 1, 4, 8, 16, and 32 parallel users. Since similar prediction errors can be observed under all scenarios, the results of the class clustering analysis are provided only for 4 and 16 parallel users in Table 5:

TABLE 5
Relative Prediction Error^{†} under Class Clustering
compared with 22 Class Scenario on Single Server

| Clus- | U (Utili- | | M (Memory | | W (Response | | X (Through- | |
|---|---|---|---|---|---|---|---|---|
| ters | zation) | | Occupation) | | Time) | | put) | |
| C | Con4 | Con16 | Con4 | Con16 | Con4 | Con16 | Con4 | Con16 |
| 2 | 0.46 | 0.59 | 0.46 | 0.54 | 0.09 | 0.23 | 0.01 | 0.02 |
| 4 | 0.04 | 0.02 | 0.05 | 0.18 | 0.07 | 0.22 | 0.01 | 0.01 |
| 8 | 0.00 | 0.00 | 0.01 | 0.01 | 0.01 | 0.01 | 0.00 | 0.00 |
| 16 | 0.00 | 0.00 | 0.00 | 0.00 | 0.00 | 0.00 | 0.00 | 0.00 |
| 20 | 0.00 | 0.00 | 0.00 | 0.00 | 0.00 | 0.00 | 0.00 | 0.00 |
| 22 | 0.00 | 0.00 | 0.00 | 0.00 | 0.00 | 0.00 | 0.00 | 0.00 |

^{†}Relative prediction error: |estimate-reference|/reference

As expected, as more classes are used, the prediction gets more accurate. However, note that reducing the original class set from 22 classes down to 8 class clusters only slightly effects the prediction accuracy, whereas further clustering increases prediction errors notably. While errors using 4 class classes are still acceptable, it is not recommended to use fewer clusters on the dataset, since doing so can result in utilization and memory occupation estimates at an approximate error of 50%. Based on these results, it can be decided to consider 4, 8 and 16 classes for the evaluation of the optimization program described above.

For equation 411, there is applied a specific objective to F in equation 410a. The objective is to minimize the sum of the memory occupation over all servers, whereby there is defined the memory occupation for each server as sum over the products of per-class queue length and per-class memory occupation, e.g., for determining equation 412.

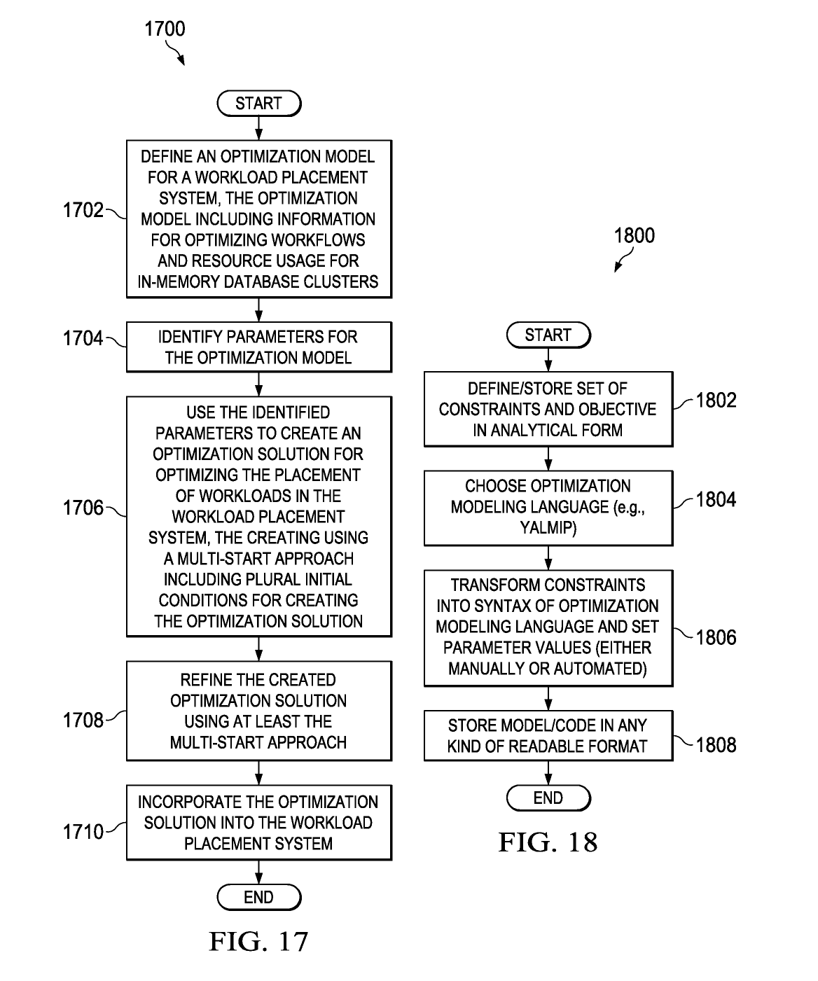

FIG. 17 is a flow diagram for an example process 1700 for creating and incorporating an optimization solution into a workload placement system. For example, the workload placement system 112 can perform the steps of the process 1700, as described above with reference to FIG. 1A. FIGS. 1A-16 provide examples of concepts, experimentation, solutions and processes for creating and incorporating an optimization solution into the workload placement system 112.

At 1702, an optimization model is defined for a workload placement system.

The optimization model includes information for optimizing workflows and resource usage for in-memory database clusters. For example, the optimization module 116 can create the optimization model 111. A justification for defining the optimization model 111 is described above, including with reference to FIGS. 1A-4. The corresponding description provide example structures associated with some implementations of this step.

In some implementations, defining the optimization model includes additional the use of optimization objectives for the optimization model. For example, at least one optimization objective is identified for the optimization model. Optimization objectives can include (or be related to), for example, query response times, query throughputs, memory occupation, and hardware/energy cost. Response time, throughput and resource constraints can be identified and added to an optimization program in the workload placement system. The response time, throughput and resource constraints can include, for example, a maximum response time, a minimum throughput, a maximum server utilization, and a maximum memory usage. The identifying and adding can use the at least one optimization objective. Performance model constraints can be set in the optimization program.

At 1704, parameters are identified for the optimization model. For example, the parameterization module 120 can identify parameters for the optimization model 111. Parameterization is described above, for example, with respect to FIGS. 4 and 5.

In some implementations, identifying parameters for the optimization model includes the use of different types of parameters. For example, service level objective parameters can be identified, including actual values for response time and throughput constraints. Resource constraint parameters can be identified, including actual values for server utilization and memory occupation. Traces can be generated for use in the workload placement system, the traces creating a trace set for collecting monitored performance of in-memory database clusters. Performance-based parameters can be extracted from the created trace set for use in the optimization model.

At 1706, using the identified parameters, an optimization solution is created for optimizing the placement of workloads in the workload placement system. The creating uses a multi-start approach including plural initial conditions for creating the optimization solution. For example, the optimization module 116 can use the identified parameters to create the optimization solution 113 for the optimization model 111. Example structures associated with some implementations of this step are provided above.

At 1708, the created optimization solution is refined using at least the multi-start approach. For example, the refining module 122 can use the optimization solution 113 to refine the optimization model 111. Example structures associated with some implementations of this step are provided above.

In some implementations, refining the optimization solution can include updating the optimization program in the workload placement system and refining the optimization solution based at least on the updating. For example, updating the optimization program in the workload placement system can include using at least load-dependent contention probabilities in the optimization program. In another example, updating the optimization program in the workload placement system can include replacing performance model constraints in the optimization program with improved performance model constraints.

At 1710, the optimization solution is incorporated into the workload placement system. For example, the workload placement system 112 can begin using the optimization solution 113 for jobs received by the server 104. In some implementations, incorporating the optimization solution into workload placement system includes applying the class routing probabilities to the classes of current workloads. Example structures associated with some implementations of this step are provided above.

In some implementations, the process 1700 further includes pre-processing classes of workloads in the workload placement system. For example, the pre-processing can occur prior to incorporating the optimization solution into the workload placement system. The pre-processing can include performing a complexity reduction on the workloads, e.g., including clustering classes of current workloads into a subset of classes of related workloads, including creating a reduced number of classes of workloads.

In some implementations, the process 1700 further includes post-processing the classes of the workloads. For example, the post-processing occurring prior to incorporating the optimization solution into workload placement system. The post-processing can include, for example, using class clusters identified in pre-processing the classes of workloads and assigning original classes the same routing probability as the class cluster to which a class belongs.

FIG. 18 is a flow chart showing an example process 1800 for using constraints to generate a model. For example, the process 1800 can be used in association with models and a multi-start based approach described above with reference to FIGS. 11A-11B.

At 1802, a set of constraints and an objective are defined and stored in analytical form, as described above. At 1804, an optimization modeling language is chosen, such as YALMIP or some other language for modeling and solving optimization problems. At 1806, constraints are transformed into a syntax of optimization modeling language and parameter values are set (either manually or automated). In some implementations, the following pseudo code, for example, can be used for transforming the constraints:

% ----- Define parameters values / constants -----

Uₘₐₓ = 0.95 //maximum server utilization
Nᵣ = [8, 3, 5, 6] //number of per-class jobs

% ----- Define decision variables -----

pᵢᵣ //class routing probabilities

% ----- Assign one initial condition ic from multi-start point set -----

pᵢᵣ = ic

% ----- Define constraints -----

Constraints = [ ]
Constraints = [Constraints, 0 <= pᵢᵣ <= 1]
Constraints = [Constraints, 0 <= Uᵢ <= Uₘₐₓ]
Constraints = [Constraints, ...]

% ----- Define objective -----

Nᵢᵣ = Nr * pᵢᵣ //apply class routing probabilities to number of
per-class jobs
Uᵢ(Nᵢᵣ) //define utilization as function of workload
F = min: max(Uᵢ) //exemplary objective: minimizing the maximum
server utilization

At 1808, the model and/or applicable code is stored in any kind of readable format, as described above.

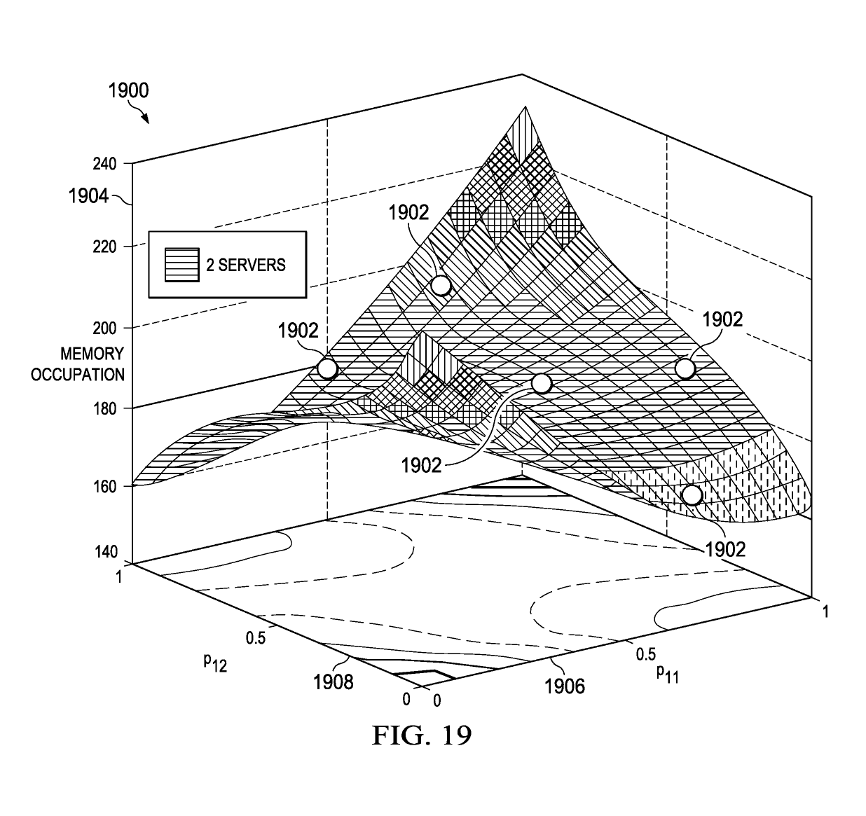

FIG. 19 shows a graph 1900 representing an example for creating an optimization solution using a multi-start approach. In the graph 1900, pᵢᵣ dot values 1902 represent the set of initial conditions used for the multi-start approach. In some implementations, the optimization can be run several times, e.g., each time starting at a different initial condition, to find the best optimum.

For example, the graph 1900 represents memory occupation 1904 for two classes. The z-axis of the graph 1900 is the memory occupation 1904. An x-axis 1906 represents a p₁₁ probability, e.g., the routing probability of class 1 to server 1. A y-axis 1908 represents a p₁₂ probability, e.g., the routing probability of class 2 to server 1. The probabilities are applicable to a first server (e.g., server 1). Routing probabilities for server 2 can be defined as: p₂₁=1−p₁₁, and p₂₂=1−p₁₂.

In some implementations, the following pseudocode/conditions can be used in an approach associated with the graph 1900:

Define:
decision variable pir, objective F, constraints C and solver settings S
run optimization:
i = 0
bestSolution.pᵢᵣ = [ ]
bestSolution.F = Infinity
for all initial conditions ic
do

assign(pᵢᵣ, ic)
solution = solveOptimizationModel(F(pᵢᵣ), C, S)
if solution.F < bestSolution.F

bestSolution.F = solution.F
bestSolution.pᵢᵣ = solution.pᵢᵣ

end

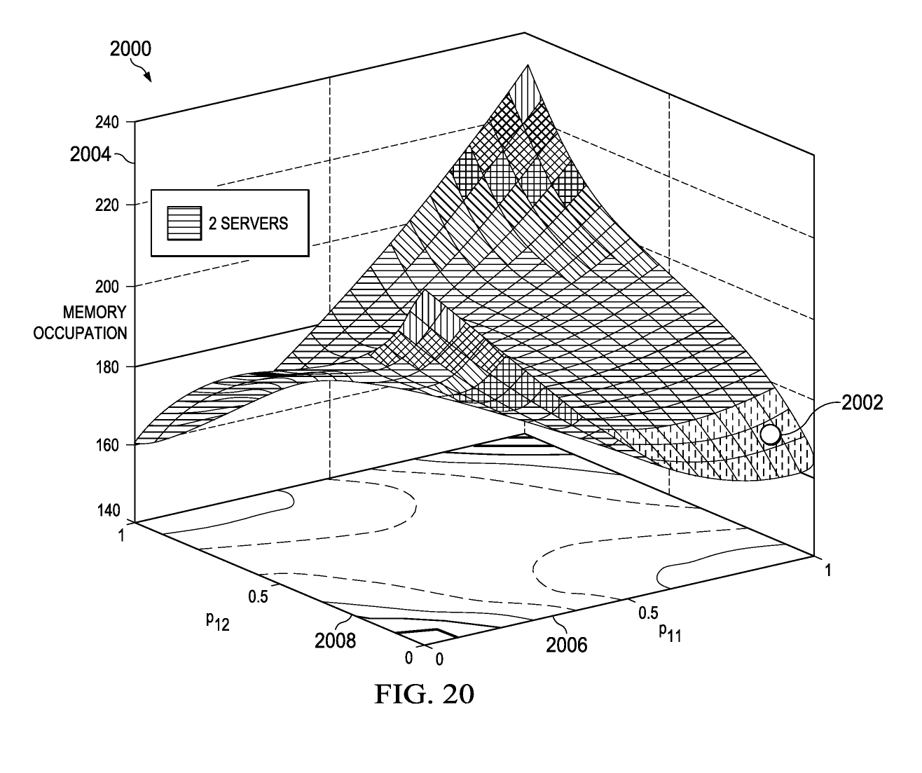

FIG. 20 shows a graph 2000 representing an example for creating an optimization solution using a refinement approach. In the graph 2000, pᵢᵣ dot value 2002 represents the best solution found by the multi-start approach. This point can be used, for example, for further refinement of an optimization.

For example, the graph 2000 represents memory occupation 2004 for two classes. The z-axis of the graph 2000 is the memory occupation 2004. An x-axis 2006 represents a p₁₁ probability, e.g., the routing probability of class 1 to server 1. A y-axis 2008 represents a p₁₂ probability, e.g., the routing probability of class 2 to server 1.

In some implementations, the following pseudocode/conditions can be used in an approach associated with the graph 2000:

define:
decision variable pᵢᵣ, objective F, constraints C and solver settings S
improve constraints:
C_{improved} = improve(C) //e.g. using a better analytical model and add this
to C run optimization:
assign(pᵢᵣ, bestSolutionFromMultiStart.pᵢᵣ)
solution = solveOptimizationModel(F(pᵢᵣ), C_{improved}, S)

Devices can encompass any computing device such as a smart phone, tablet computing device, PDA, desktop computer, laptop/notebook computer, wireless data port, one or more processors within these devices, or any other suitable processing device. For example, a device may comprise a computer that includes an input device, such as a keypad, touch screen, or other device that can accept user information, and an output device that conveys information associated with components of the environments and systems described above, including digital data, visual information, or a graphical user interface (GUI). The GUI interfaces with at least a portion of the environments and systems described above for any suitable purpose, including generating a visual representation of a Web browser.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although this disclosure has been described in terms of certain implementations and generally associated methods, alterations and permutations of these implementations, and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A method comprising:
defining an optimization model for a workload placement system, the optimization model including information for optimizing workflows and resource usage for in-memory database clusters;
identifying parameters for the optimization model;
creating, using the identified parameters, an optimization solution for optimizing the placement of workloads in the workload placement system, the creating using a multi-start approach including plural initial conditions for creating the optimization solution;
refining the created optimization solution using at least the multi-start approach; and
incorporating the optimization solution into the workload placement system.

2. The method of claim 1, wherein defining the optimization model includes:
identifying at least one optimization objective for the optimization model, the at least one optimization objective selected from a group comprising query response times, query throughputs, memory occupation, and hardware/energy cost;
identifying and adding response time, throughput and resource constraints to an optimization program in the workload placement system, the response time, throughput and resource constraints including a maximum response time, a minimum throughput, a maximum server utilization, and a maximum memory usage, the identifying and adding using the at least one optimization objective; and
setting performance model constraints in the optimization program.

3. The method of claim 1, wherein identifying parameters for the optimization model includes:
identifying service level objective parameters, including actual values for response time and throughput constraints;
identifying resource constraint parameters, including actual values for server utilization and memory occupation;
generating traces for use in the workload placement system, the traces creating a trace set for collecting monitored performance of in-memory database clusters, and
extracting, from the created trace set, performance-based parameters for use in the optimization model.

4. The method of claim 1, wherein refining the optimization solution includes:
updating the optimization program in the workload placement system; and
refining the optimization solution based at least on the updating.

5. The method of claim 4, wherein updating the optimization program in the workload placement system includes using at least load-dependent contention probabilities in the optimization program.

6. The method of claim 4, wherein updating the optimization program in the workload placement system includes replacing performance model constraints in the optimization program with improved performance model constraints.

7. The method of claim 1, further comprising:
pre-processing classes of workloads in the workload placement system, including performing a complexity reduction on the workloads, the pre-processing occurring prior to incorporating the optimization solution into the workload placement system, and the pre-processing including:
clustering classes of current workloads into a subset of classes of related workloads, including creating a reduced number of classes of workloads.

8. The method of claim 7, further comprising:
post-processing the classes of the workloads, including using class clusters identified in pre-processing the classes of workloads and assigning original classes the same routing probability as the class cluster a class belongs to, the post-processing occurring prior to incorporating the optimization solution into workload placement system.

9. The method of claim 1, wherein incorporating the optimization solution into workload placement system includes applying the class routing probabilities to the classes of current workloads.

10. A system comprising:
memory storing:
an optimization model defined for a workload placement system, the model including information for optimizing workflows and resource usage for in-memory database clusters, including workloads processed by the server; and
an optimization solution for placement and execution of the workloads by the server; and
an application for:
defining the optimization model for a workload placement system, the optimization model including information for optimizing workflows and resource usage for the in-memory database clusters;
identifying parameters for the optimization model;
creating, using the identified parameters, the optimization solution for optimizing the placement of workloads in the workload placement system, the creating using a multi-start approach including plural initial conditions for creating the optimization solution;
refining the created optimization solution using at least the multi-start approach; and
incorporating the optimization solution into the workload placement system.

11. The system of claim 10, wherein defining the optimization model includes:
identifying at least one optimization objective for the optimization model, the at least one optimization objective selected from a group comprising query response times, query throughputs, memory occupation, and hardware/energy cost;
identifying and adding response time, throughput and resource constraints to an optimization program in the workload placement system, the response time, throughput and resource constraints including a maximum response time, a minimum throughput, a maximum server utilization, and a maximum memory usage, the identifying and adding using the at least one optimization objective; and
setting performance model constraints in the optimization program.

12. The system of claim 10, wherein identifying parameters for the optimization model includes:
identifying service level objective parameters, including actual values for response time and throughput constraints;
identifying resource constraint parameters, including actual values for server utilization and memory occupation;
generating traces for use in the workload placement system, the traces creating a trace set for collecting monitored performance of in-memory database clusters, and
extracting, from the created trace set, performance-based parameters for use in the optimization model.

13. The system of claim 10, wherein refining the optimization solution includes:
updating the optimization program in the workload placement system; and
refining the optimization solution based at least on the updating.

14. The system of claim 13, wherein updating the optimization program in the workload placement system includes using at least load-dependent contention probabilities in the optimization program.

15. The system of claim 13, wherein updating the optimization program in the workload placement system includes replacing performance model constraints in the optimization program with improved performance model constraints.

16. A non-transitory computer-readable media encoded with a computer program, the program comprising instructions that when executed by one or more computers cause the one or more computers to perform operations comprising:
defining an optimization model for a workload placement system, the optimization model including information for optimizing workflows and resource usage for in-memory database clusters;
identifying parameters for the optimization model;
creating, using the identified parameters, an optimization solution for optimizing the placement of workloads in the workload placement system, the creating using a multi-start approach including plural initial conditions for creating the optimization solution;
refining the created optimization solution using at least the multi-start approach; and
incorporating the optimization solution into the workload placement system.

17. The non-transitory computer-readable media of claim 16, wherein defining the optimization model includes:
identifying at least one optimization objective for the optimization model, the at least one optimization objective selected from a group comprising query response times, query throughputs, memory occupation, and hardware/energy cost;
identifying and adding response time, throughput and resource constraints to an optimization program in the workload placement system, the response time, throughput and resource constraints including a maximum response time, a minimum throughput, a maximum server utilization, and a maximum memory usage, the identifying and adding using the at least one optimization objective; and
setting performance model constraints in the optimization program.

18. The non-transitory computer-readable media of claim 16, wherein identifying parameters for the optimization model includes:
identifying service level objective parameters, including actual values for response time and throughput constraints;
identifying resource constraint parameters, including actual values for server utilization and memory occupation;
generating traces for use in the workload placement system, the traces creating a trace set for collecting monitored performance of in-memory database clusters, and
extracting, from the created trace set, performance-based parameters for use in the optimization model.

19. The non-transitory computer-readable media of claim 16, wherein refining the optimization solution includes:
updating the optimization program in the workload placement system; and
refining the optimization solution based at least on the updating.

20. The non-transitory computer-readable media of claim 19, wherein updating the optimization program in the workload placement system includes using at least load-dependent contention probabilities in the optimization program.
